(19) United States
(12) Patent Application Publication
(10) Pub. No.: US 2014/0249893 A1
(43) Pub. Date: Sep. 4, 2014

(54) AGRICULTURAL PERFORMANCE INFORMATION SYSTEMS AND RELATED METHODS

(71) Applicant: MachineryLink, Inc., Kansas City, MO (US)

(72) Inventors: Robert McClure, Suwanee, GA (US); Jay Lang, Leawood, KS (US); Landon Morris, Lincoln, NE (US); William C. Mayes, Tacoma, WA (US)

(73) Assignee: MachineryLink, Inc., Kansas City, MO (US)

(21) Appl. No.: 14/279,091

(22) Filed: May 15, 2014

Related U.S. Application Data
(63) Continuation-in-part of application No. 12/539,376, filed on Aug. 11, 2009.
(60) Provisional application No. 61/941,174, filed on Feb. 18, 2014.
(60) Provisional application No. 61/188,562, filed on Aug. 11, 2008.

(51) Int. Cl. G06Q 10/06

(52) U.S. Cl. CPC G06Q 10/06393
USPC 705/7.39

(57) ABSTRACT

Embodiments of agricultural performance information systems are presented and disclosed herein. Other examples and related methods are also disclosed herein.

### CLAIM OF PRIORITY

This patent application is non-provisional application of U.S. Provisional Application No. 61/941,174, filed Feb. 18, 2014. This patent application is also a continuation-in-part patent application of U.S. patent application Ser. No. 12/539,376, filed on Aug. 11, 2009, which is a non-provisional patent application claiming priority to U.S. Provisional Patent Application No. 61/188,562, filed on Aug. 11, 2008. The disclosures referenced above are incorporated herein by reference in their entirety.

### TECHNICAL FIELD

This disclosure relates generally to information systems, and relates more particularly to agricultural performance information systems and related methods.

### BACKGROUND

With the continued mechanization of the agricultural industry, it has become possible to gather crop production data from the machines used in production agriculture. Such data, however, is normally visible or available only to the entity that collects it, whether the entity is a farmer or an organization operating the agricultural machines. As a result, the data cannot be gathered and/or aggregated either to estimate or predict its effects at macro scale levels, and/or to benchmark performance of localized agricultural operations. For the same reasons, the estimations, predictions, and benchmarking described above cannot be presently carried out in real time.

Accordingly, a need exists for a system, process, and/or method that allows real time gathering, aggregation, and/or benchmarking of agricultural data to overcome at least the limitations described above.

### BRIEF DESCRIPTION OF THE DRAWINGS

FIG. 1 illustrates a diagram of a first data gathering mechanism coupled to a first agricultural machine as part of a system for generating agricultural data reports, such as operational, mechanical, or production data reports.

FIG. 2 illustrates a diagram of the system of FIG. 1, further comprising a data processing mechanism coupled to the first data gathering mechanism via a network.

FIG. 3 illustrates a computer that can be suitable for implementing an embodiment of the data processing mechanism of FIG. 2.

FIG. 4 illustrates a representative block diagram of elements of the computer of FIG. 3.

FIG. 5 illustrates a flowchart for a method that can be used for providing an agricultural reporting mechanism.

FIG. 6 illustrates an exemplary view of a yield report of a harvest field.

FIG. 7 illustrates several portions or data of an aggregate data set.

FIG. 8 illustrates a soil-zones map report for the harvest field of FIG. 6.

FIG. 9 illustrates a report with a soil-zones yield map for the harvest field of FIG. 6.

FIG. 10 presents a subspace benchmark report for a first subspace of the harvest field of FIG. 6.

FIG. 11 presents a subspace benchmark report for a second subspace of the harvest field of FIG. 6.

FIG. 12 illustrates a view of a field zone benchmark report of the harvest field of FIG. 6.

FIG. 13 illustrates a view of a field benchmark report of the harvest field of FIG. 6.

FIG. 14 illustrates a flowchart for a method that can be used for processing aggregate harvest data gathered by a plurality of data gathering mechanism sets for a plurality of harvest fields.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

An electrical “coupling” and the like should be broadly understood and include coupling involving any electrical signal, whether a power signal, a data signal, and/or other types or combinations of electrical signals. A mechanical “coupling” and the like should be broadly understood and include mechanical coupling of all types. The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION

In one example, a system can comprise a first data gathering mechanism set and a data processing mechanism set. The first data gathering mechanism set can be configured to gather a first operational data set during operation of a first agricultural machine set, and to transmit the first operational data set to a network. The first operational data set can comprise information representative of one or more characteristics of an agricultural crop during production. The data processing mechanism can be configured to store a combined data set comprising the first operational data set, and generate one or more reports based on the combined data set.

In one embodiment, a system for processing aggregate harvest data gathered by a plurality of data gathering mechanism sets for a plurality of harvest fields can comprise a data processing module configured to receive first field harvest data of a first harvest field of the plurality of harvest fields, to receive the aggregate harvest data for the plurality of harvest fields from a database, and to calculate, from the aggregate harvest data, a first subspace yield benchmark for a first subspace of the first harvest field. The aggregate harvest data can comprise aggregate subspace datasets from subspaces of the plurality of harvest fields. Each of the aggregate subspace datasets an comprise an aggregate subspace harvest yield, and an aggregate subspace environment condition. The first field harvest data can comprise a first subspace dataset of the first subspace of the first harvest field. The first subspace dataset can comprise a first subspace harvest yield and a first subspace environment condition. The data processing module can calculate the first subspace yield benchmark from the aggregate subspace harvest yields whose respective aggregate subspace environment condition corresponds to the first subspace environment condition of the first harvest field.

In one embodiment, a system for processing aggregate harvest data gathered by a plurality of data gathering mechanism sets for a plurality of harvest fields can comprise a data processing module configured to receive first field harvest data of a first harvest field of the plurality of harvest fields, and to generate a report for the first harvest field based on the first field harvest data. The first field harvest data can comprise a plurality of subspace datasets for a plurality of subspaces of the first harvest field. The plurality of subspaces can comprise a first subspace of the first harvest field, and a second subspace of the first harvest field. The plurality of subspace datasets can comprise a first subspace dataset for the first subspace, comprising a first subspace location and a first subspace harvest yield. A second subspace dataset for the second subspace can comprise a second subspace location, and a second subspace harvest yield. The data processing module can be configured to calculate, from the plurality of subspace datasets, a first field harvest yield of the first harvest field. The report can be configured by the data processing module to present the first field harvest yield of the first harvest field.

In one implementation, a method for processing aggregate harvest data gathered by a plurality of data gathering mechanism sets for a plurality of harvest fields can comprise (a) receiving, at a data processing module, first field harvest data of a first harvest field of the plurality of harvest fields, (b) receiving, at the data processing module, the aggregate harvest data for the plurality of harvest fields from a database, and (c) calculating from the aggregate harvest data, with the data processing module, a first subspace yield benchmark for a first subspace of the first harvest field. The aggregate harvest data can comprise aggregate subspace datasets from subspaces of the plurality of harvest fields. Each of the aggregate subspace datasets can comprise an aggregate subspace harvest yield, and an aggregate subspace environment condition. The first field harvest data can comprise a first subspace dataset of the first subspace of the first harvest field. The first subspace dataset can comprise a first subspace harvest yield, and a first subspace environment condition. Calculating the first subspace yield benchmark can comprises combining the aggregate subspace harvest yields of the subspaces of the plurality of harvest fields whose respective aggregate subspace environment condition corresponds to the first subspace environment condition of the first harvest field.

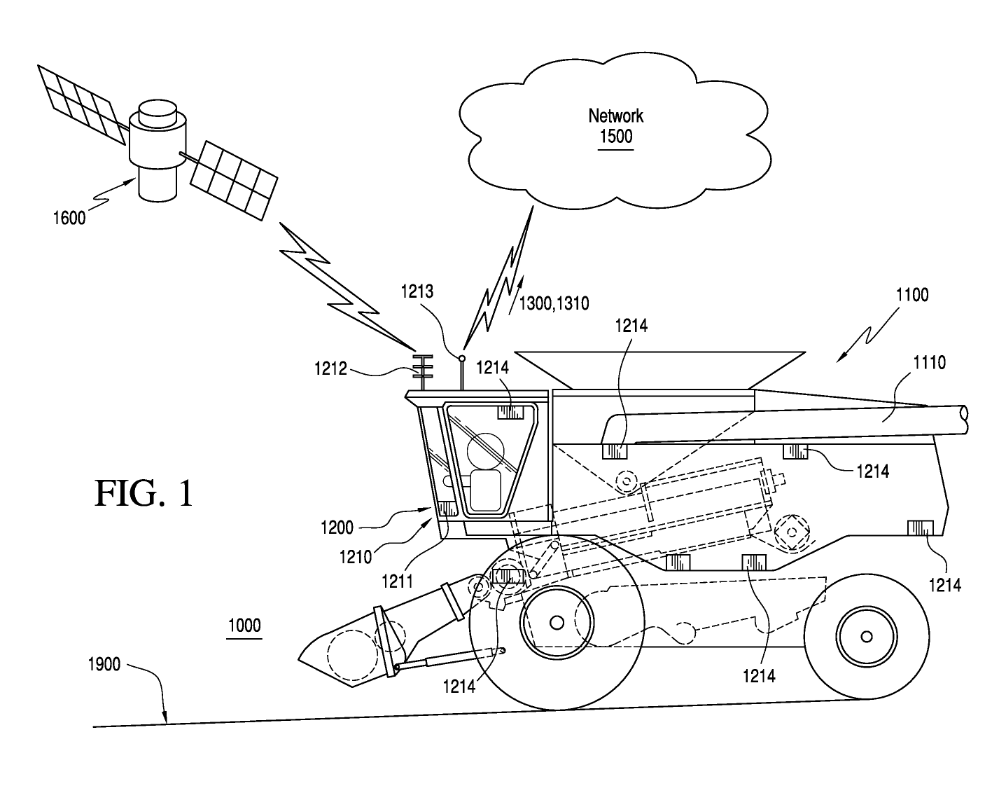

Referring now to the figures, FIG. 1 illustrates a diagram of agricultural machine 1110 as part of agricultural machine set 1100 of system 1000. In the present example, system 1000 can represent a system for collecting, aggregating, processing, and/or transmitting information about agricultural machine set 1100 during one or more operations related to the production of agricultural crops. In some examples, the information about agricultural machine set can relate to operating parameters (e.g., rotor speed, concave settings, ground speed), mechanical parameters (e.g., oil temperature, fluid pressure, fuel consumption), and/or production parameters (e.g., yield and/or moisture of crops). Agricultural machine 1110 is presented herein as a combined harvester and thresher (“combine”) for harvesting crops in the present example, although in other examples agricultural machine 1110 could comprise other types of agricultural machines or equipment, including other equipment used to process and/or harvest crops, such as forage harvesters, cotton harvesters, cane harvesters, planters, and/or sprayers.

Agricultural machine 1110 is shown coupled to data gathering mechanism 1210 in the present example, where data gathering mechanism 1210 forms part of data gathering mechanism set 1200. Data gathering mechanism 1210 is configured to gather operational data 1310 during operation of agricultural machine 1110, and to transmit operational data 1310 to network 1500 for storage and/or further processing.

In some embodiments, data gathering mechanism set 1200 can comprise further data gathering mechanisms similar to data gathering mechanism 1210 but coupled to other agricultural machines (not shown) of agricultural machine set 1100. In such examples, other operational data from such further data gathering mechanisms may also be sent to network 1500 along with operational data 1310 as part of operational data set 1300.

Data gathering mechanism 1210 comprises several components in the present example, such as GPS receiver 1212 configured to communicate with one or more GPS satellites 1600 and thereby determine, as part of operational data 1310, a geographical location of data gathering mechanism 1210 and/or of agricultural machine 1110. Data gathering mechanism 1210 also comprises operation monitor 1211 coupled to GPS receiver 1212 and to crop production sensors 1214 in the present example, where operation monitor 1211 is configured to gather, as part of operational data 1310, information about one or more parameters of agricultural machine 1110 via crop production sensors 1214 and/or GPS receiver 1212.

In some examples, the one or more parameters of agricultural machine 1110 can comprise operating parameters, mechanical parameters, and/or production parameters. As an example, the operating parameters for an agricultural machine can comprise information about geographical location, ground speed, feeder house speed, rotor speed, chopper speed, tailboard speed, fan speed, shoe settings (e.g., chaffer settings and/or sieve settings), tailings elevator settings, concave settings, header position, header specifications, header size, and/or operator settings, among others. In the same or other embodiments, the mechanical parameters for an agricultural machine can comprise information about engine performance, such as engine speed, engine hours, fuel pressure, horsepower percentage use, hydraulic pressure, hydraulic flow, battery voltage, fuel consumption, oil pressure, air inlet temperature, boost pressure, intake manifold temperature, separator hours, and/or engine temperature. The mechanical parameters can also comprise information about drivetrain performance, such as information about drivetrain stress, gearing, pressure, power-rear wheel assist engagement, and/or temperature. The production parameters can comprise information about, for example, yield, grain loss, and/or moisture of a crop being harvested.

In some embodiments, operation monitor 1211 can be also configured to gather information about harvesting from a specific location, such as a field, as the field is harvested by agricultural machine 1110. In the same or other embodiments, the information about the harvesting from the field can comprise one or more of a harvest field map, a harvest field area, a crop weight value, a yield value, a yield per unit of area, a moisture content, and/or a hillside compensation setting, among others.

Data gathering mechanism 1210 also comprises transmitter 1213 in the present example, where transmitter 1213 is coupled to at least one of operation monitor 1211 and/or GPS receiver 1212 and configured to transmit operational data 1310 to network 1500. Although transmitter 1213 couples with network 1500 via a cellular network configuration in the present example, other wireless standards, such as Wi-Fi, may also be supported in other examples. Transmitter 1213 can be configured to transmit operational data 1310 continuously to network 1500 during operation of agricultural machine 1110 as operational data 1310 is gathered by data gathering mechanism 1210. In other examples, transmitter 1213 can be configured to transmit operational data 1310 upon completion of an operating step or task during the operation of agricultural machine 1110. There can also be examples where data gathering mechanism 1210 can also comprise a receiver to wirelessly receive signals from network 1500, such as signals with instructions for data gathering mechanism 1210 to gather and/or transmit specific information related to the operation of agricultural machine 1110.

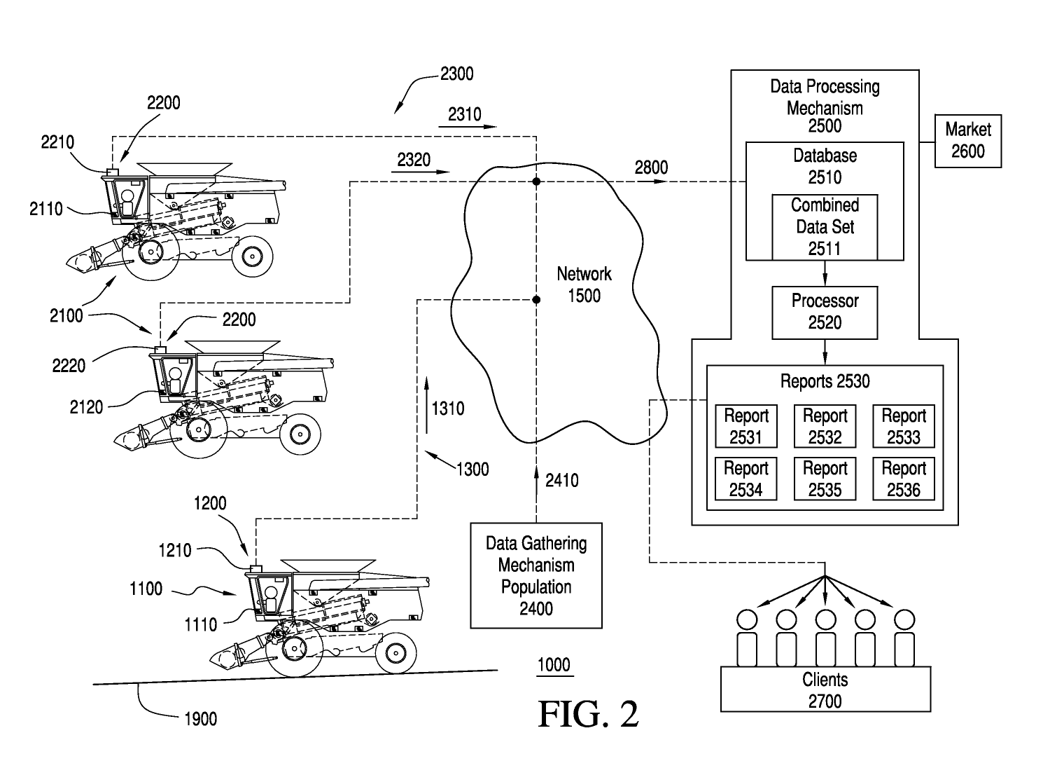

In the present embodiment, data gathering mechanism 1210 comprises commercial off the shelf (COTS) components communicatively coupled together to gather and transmit operational data 1310. For example, in one embodiment, operation monitor 1211 can comprise a Ceres 8000i yield monitor available from Loup Electronics of Lincoln, Nebr. In the same or a different embodiment, GPS receiver 1212 can comprise a Synpak E GPS receiver, available through SimpleComTools of Indian Trail, N.C., and/or a GSynQ/T MK-1 Smart GPS Antenna, available from Synergy Systems, LLC of San Diego, Calif. In the same or other embodiments, transmitter 1213 can comprise a TC65T Wireless Module, available from Cinterion Wireless Modules of Munich, Germany. Continuing with the figures, FIG. 2 illustrates a diagram of system 1000 comprising data processing mechanism 2500 coupled to data gathering mechanism 1210 via network 1500. Data gathering mechanism 1210 is still coupled to agricultural machine 1110 and to network 1500 as shown in FIG. 1, but FIG. 2 further illustrates that network 1500 can support other data gathering mechanism sets as coupled to other agricultural machine sets other than agricultural machine set 1100. For example, data gathering mechanism set 2200 is shown coupled to agricultural machine set 2100 to transmit operational data set 2300 to network 1500, similar to as described above for FIG. 1 with respect to data gathering mechanism set 1200 coupled to agricultural machine set 1100 to transmit operational data set 1300. In the same or other examples, network 1500 can comprise one or more interconnected networks and network interfaces. For example, data gathering mechanisms can couple with network 1500 via a cellular network interface, while data processing mechanism 2500 can couple to network 1500 via the internet.

As seen in FIG. 2, data processing mechanism is also coupled to clients 2700 via network 1500, where clients 2700 can comprise, for example, electronic terminals operated by subscribers or operators of data processing mechanism 2500 to request and/or access reports 2530. There can be examples where one or more of reports 2530 can comprise raw data made accessible to clients 2700, where the raw data may be based on, for example operational data sets 1300 and/or 2300. In the same or other examples, data processing mechanism 2500 may generate one or more of reports 2530 after processing and/or applying computing algorithms to the raw data. Reports 2530 can be printed or delivered upon request and/or periodically to clients 2700. In the same or other examples, one or more or reports 2530 can be displayed at a screen of an electronic terminal of one or more of the clients 2700. There can also be examples where the one or more reports 2530 can be updated in real time, based on updates to data received by data processing mechanism 2500, such as when displayed on a screen as described above. Clients 2700 may couple to data processing mechanism 2500 via an internet connection through network 1500 in some examples.

In the same or other examples, data processing mechanism 2500 can be configured to control access to reports 2530 based on a user profile of specific ones of clients 2700. User profiles may be structured based on one or more subscription levels available for clients 2700 to access data processing mechanism 2500 and/or reports 2530. For example, a first one of clients 2700 may be given access only to certain reports of reports 2530, and/or only to reports generated using certain portions of data in data processing mechanism 2500. In the same or other examples, the access or delivery of reports 2530 may be established based on a preference set for a user profile. For example, a user profile may be set such that one or more of reports 2530 are accessible upon request and/or to such that one or more of reports 2530 are periodically “pushed” or delivered to one of clients 2700, such as via email. User profiles may comprise, in some examples, a username and password combination. Data processing mechanism may be configured to restrict access altogether when a user profile is unrecognized.

In the present example of FIG. 2, agricultural machine set 2100 comprises more than one agricultural machine, namely agricultural machines 2110 and 2120, coupled respectively to data gathering mechanisms 2210 and 2220 of data gathering mechanism set 2200 to respectively transmit operational data 2310 and 2320 to network 1500. There can be further examples where other data gathering mechanism sets and corresponding agricultural machine sets can also be connected to network 1500 as part of system 1000, whether such agricultural machine sets comprise only a single agricultural machine and a single data gathering mechanism, as for agricultural machine set 1100, or a plurality of agricultural machines and a plurality of data gathering mechanisms, as for agricultural machine set 2100. In the present example, such other data gathering mechanism sets can form part of data gathering mechanism population 2400.

Data processing mechanism 2500 is configured in FIG. 2 to communicate with data gathering mechanism sets 1200 and 2200 via network 1500, and comprises database 2510 and processor 2520. Database 2510 is configured to store combined data set 2511, where combined data set 2511 can be generated and/or organized by data processing mechanism 2500 based on operational data set 1300 from data gathering mechanism set 1200 and/or on operational data set 2300 from data gathering mechanism set 2200. Data processing mechanism 2500 also comprises processor 2520 to generate one or more reports 2530 based on combined data set 2511.

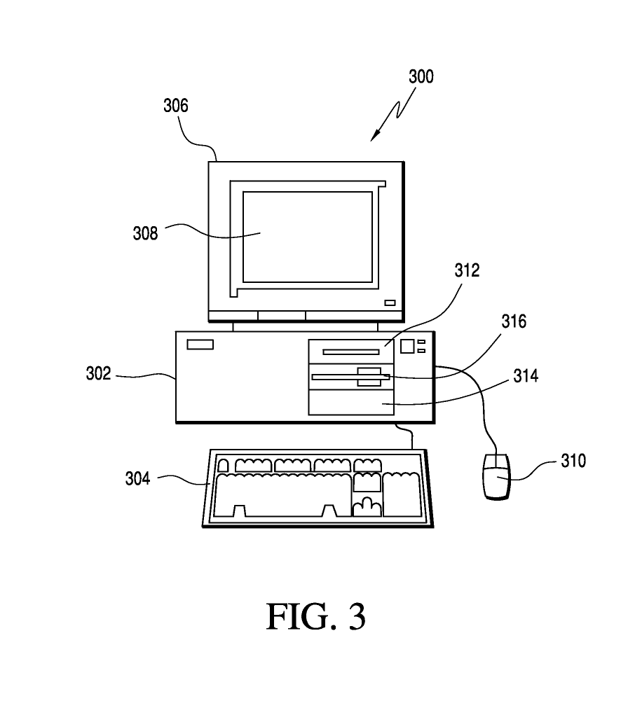

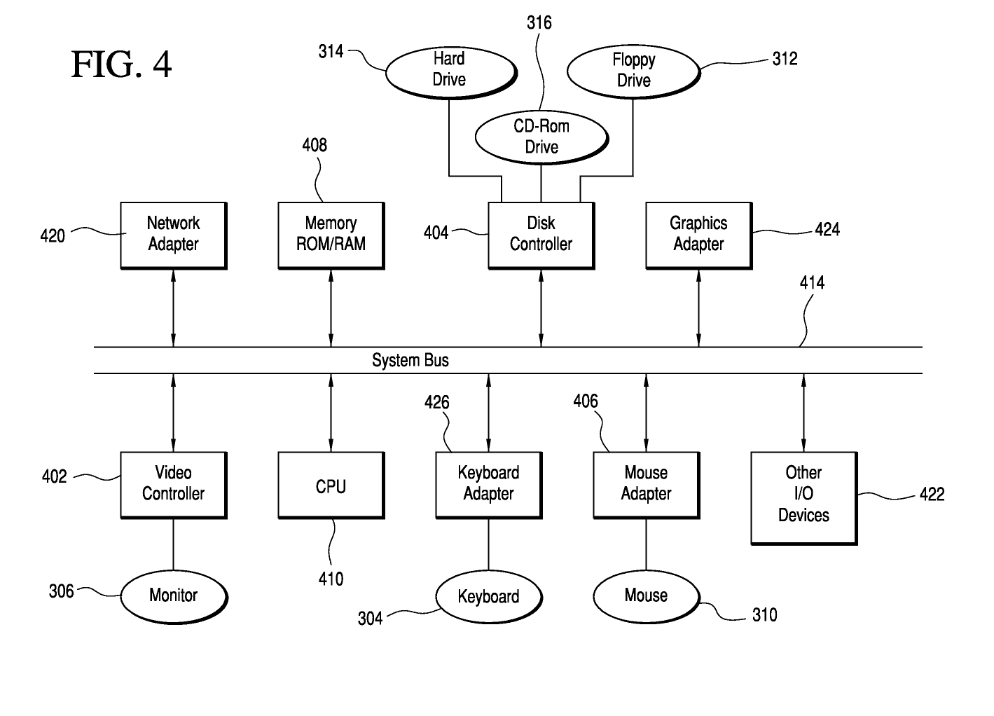

Data processing mechanism 2500 can be implemented in some examples as a computer. FIG. 3 illustrates a computer 300 that can be suitable for implementing an embodiment of data processing mechanism 2500 (FIG. 2). Computer 300 includes a chassis 302 containing one or more circuit boards (not shown), a floppy drive 312, a Compact Disc Read-Only Memory (CD-ROM) drive 316, and a hard drive 314. In some embodiments, hard drive 314 can comprise part of database 2510 (FIG. 2). A representative block diagram of the elements included on the circuit boards inside chassis 1202 is shown in FIG. 4. A central processing unit (CPU) 410 is coupled to system bus 414 in FIG. 4. There can be embodiments where CPU 410 can comprise a portion of processor 2520 (FIG. 2). In various embodiments, the architecture of CPU 410 can be compliant with any of a variety of commercially distributed architecture families including the RS/6000 family, the Motorola 68000 family, the Intel x86 family, and other families.

System bus 14 is also coupled to memory 408, where memory 408 includes both read only memory (ROM) and random access memory (RAM). Non-volatile portions of memory 408 or the ROM can be encoded with a boot code sequence suitable for restoring computer 300 (FIG. 3) to a functional state after a system reset. In addition, memory 408 can include microcode such as a Basic Input-Output System (BIOS).

In the depicted embodiment of FIG. 4, various I/O devices such as a disk controller 404, a graphics adapter 424, a video controller 402, a keyboard adapter 426, a mouse adapter 406, a network adapter 420, and other I/O devices 422 can be coupled to system bus 414. In some examples, network adapter 420 can be coupled to network 1500 (FIGS. 1-2) to communicatively couple data processing mechanism 2500, embodied in this example as computer 300, with data gathering mechanism sets 1200 and/or 2200. and Keyboard adapter 426 and mouse adapter 406 are coupled to keyboard 304 (FIGS. 3-4) and mouse 310 (FIGS. 3-4), respectively, of computer 300 (FIG. 3). While graphics adapter 424 and video controller 402 are indicated as distinct units in FIG. 4, video controller 402 can be integrated into graphics adapter 424, or vice versa in other embodiments. Video controller 402 is suitable for refreshing monitor 306 (FIGS. 3-4) to display images on a screen 308 (FIG. 3) of computer 300 (FIG. 3). Disk controller 404 can control hard drive 314 (FIGS. 3-4), floppy drive 312 (FIGS. 3-4), and CD-ROM drive 316 (FIGS. 3-4). In other embodiments, distinct units can be used to control each of these devices separately.

Although many other components of computer 300 (FIG. 3) are not shown, such components and their interconnection are well known to those of ordinary skill in the art. Accordingly, further details concerning the construction and composition of computer 300 and the circuit boards inside chassis 302 (FIG. 3) need not be discussed herein.

When computer 300 in FIG. 3 is operated, program instructions stored on a floppy disk in floppy drive 312, on a CD-ROM in CD-ROM drive 316, on hard drive 314, and/or in memory 408 can be executed by CPU 410 (FIG. 4). In some embodiments of the data processing mechanism 2500 of FIG. 2, a portion of the program instructions stored on these devices can be suitable for carrying out the generation, organization, and/or storage of combined data set 2511, and/or the generation of the one or more reports 2530 based on combined data set 2511.

In some embodiments, data processing mechanism 2500 can be implemented as a computer system. The computer system may comprise a single computer, such as computer 300 (FIGS. 3-4), and/or a single server, such as a server comprising one or more components similar to those described for computer 300 but focused on providing access to data for multiple clients, such as clients 2700 in FIG. 2. For example, database 2510 (FIG. 2) can be implemented to comprise one or more storage components that could be similar to hard drive 314 of computer 300 (FIG. 4). Combined data set 2511 (FIG. 2) can be stored in database 2510 as part of an XML (Extensible Markup Language) database, a MySQL database, or an Oracle® database. In the same or different embodiments, the combined data set 2511 (FIG. 2) could consist of a searchable group of individual data files stored in database 2510 (FIG. 2).

There can also be examples where data processing mechanism 2500 comprises more than one computer, and/or a cluster or collection of servers that can be used when the demands by clients 2700 are beyond the reasonable capability of a single server or computer. In many embodiments, the servers in the cluster or collection of servers can be interchangeable from the perspective of clients 2700.

Continuing with the example of FIG. 2, data processing mechanism 2500 is configured to receive operational data sets 1300 and 2300 from data gathering mechanism sets 1200 and 2200, respectively, via network 1500. In some examples, the data gathering, transferring, and/or reception between data gathering mechanism sets 1200 or 2200 and data processing mechanism 2500 can occur in real time. For example, transmitter 1213 (FIG. 1) of data gathering mechanism 1210 may be configured to transmit updated data for operational data set 1300 to data processing mechanism 2500 in real time as agricultural machine 1110 is operated, whether the data is transmitted continuously throughout the operation of agricultural machine 1110, or whether the data is transmitted upon completion of a task or a predefined time interval during the operation of agricultural machine 1110. There can be examples where, when network 1500 is not accessible, data gathering mechanism 1210 can save the data for eventual transmission when network 1500 becomes available. In such examples, the data saved by data gathering mechanism 1210 can also be time-stamped.

Data processing mechanism 2500 can be configured in some embodiments to receive the updated data for operational data set 1300 in real time as soon as cleared through network 1500. Upon receipt of updated data for operational data set 1300, data processing mechanism 2500 can update combined data set 2511 in database 2510 in real time and thereby refresh the data available for reports 2530. As a result, data gathering mechanism can generate reports 2530 based on combined data set 2511, as updated in real time, such that reports 2530 can provide timely and/or current information to clients 2700.

In some embodiments, data processing mechanism 2500 can generate different kinds of reports 2530 for one or more of clients 2700. For example, one of reports 2530 can comprise performance benchmark report 2531 that can be used, for example, to compare the operation or performance of an agricultural machine set against benchmark data from prior historical operations and/or from present or historical data from other agricultural machine sets.

In one example of performance benchmark report 2531, operational data 1310, transmitted by data gathering mechanism 1210 as part of operational data set 1300 during operation of agricultural machine 1110, can comprise one or more subsets of benchmark data, such as a first geographical data set, a first environmental data set, a first yield data set, and/or a first agricultural machine setting data set. In some examples, the first geographical data set can comprise information about the geographical location where agricultural machine 1110 is operated. The first environmental data set can comprise information about environmental conditions during operation of agricultural machine 1110, such as temperature, humidity, and/or seasonal parameters. The first yield data set can comprise information about, for example, the type and yield of a crop being harvested by agricultural machine 1110. The first agricultural machine setting data set can comprise information about agricultural machine settings based on, for example, the operational and/or mechanical parameters previously described with respect to agricultural machine 1110.

To generate the performance benchmark report 2531, data processing mechanism 2500 can be configured to generate a benchmark data set out of combined data set 2511. The benchmark data set may be generated in some embodiments by processor 2520, and can comprise a benchmark geographical data set, a benchmark environmental data set, a benchmark yield data set, and/or a benchmark agricultural machine setting data set. The types of information of the benchmark data set can be similar to the types of information described above for operational data set 1300, but with respect to other operations of agricultural machine 1110, other agricultural machines of agricultural machine set 1100, or other agricultural machine sets.

In some examples, the agricultural machine sets of system 1000 need not be operated by the same entity. For example, in one embodiment, agricultural machine 1110 may be operated by a first farmer or organization, while agricultural machine set 2100 may be operated by a second farmer or organization to the first farmer. The performance benchmark report may be tailored to provide information to the first farmer or organization about present performance compared to past performance, and/or about performance with respect to the performance of the second farmer or company.

In one embodiment, the benchmark data set can comprise historical information derived from operational data set 1300 with respect to performance during prior operations of agricultural machine 1110 and/or of agricultural machine set 1100. In another embodiment, the benchmark data set can comprise present and/or historical comparative information derived from operational data set 2300 with respect to performance during present or past operations of one or more agricultural machines of agricultural machine set 2100. There can also be examples where the benchmark data set is generated at least in part based on information from a predicted performance report or a target performance report. For example, the predicted performance report can comprise a predicted yield report from the U.S. Department of Agriculture (USDA), other governmental sources, or non-governmental sources. As another example, the target performance report can be based on target production figures set by or for the operator of agricultural machine set 1100.

With the benchmark data set established, data processing mechanism 2500 can compare the first geographical data set, the first environmental data set, the first yield data set, and/or the first agricultural machine settings data set against the benchmark geographical data set, the benchmark environmental data set, the benchmark yield data set, and/or the benchmark agricultural machine setting data set. Based on said comparisons, data gathering mechanism can generate performance benchmark report 2531 to comprise a performance assessment of the operation of agricultural machine set 1100 and/or of agricultural machine 1110 relative to the benchmark information. In some examples, the performance assessment can take account of and/or report on a comparative performance summary for different numbers, types, models, brands, and/or configurations of agricultural machines relative to one another with respect to or more one seasons, crops and/or geographies.

There can be examples where data processing mechanism 2500 can be configured to generate machine settings recommendation report 2536. As agricultural machines have become more complex, operators have had to keep track of and fine tune several machine settings, such as those comprised by the first agricultural machine setting data set described above, to maximize performance of their agricultural machines. This can be a complex process, and often requires operators to overcome steep learning curves to properly set and maintain settings for their agricultural machines.

In some embodiments of system 1000, data processing mechanism 2500 can be configured to provide machine settings recommendation report 2536 with one or more recommendations for adjusting one or more machine settings of an agricultural machine. The one or more recommendations can be based, in some examples, on the performance assessment of the operation of agricultural machine set 1100 described above for performance benchmark report 2531. In the same or other examples, the one or more recommendations can be generated based on a machine setting analysis of the first agricultural machine setting data set with respect to at least one of the subsets of the benchmark data set described above. Other aspects of the first operational data set and the benchmark data set can also be considered by data processing mechanism 2500 when generating the recommendations. In some embodiments, machine settings recommendation report 2536 can be part of performance benchmark report 2531.

In one example, where two-way communication exists between data processing mechanism 2500 and data gathering mechanism 1210, data processing mechanism 2500 can be configured to adjust one or more agricultural machine settings of agricultural machine 1110 based on the machine settings analysis described above and/or on the one or more recommendations of the machine settings recommendation report 2536. In the same or other examples, one of performance benchmark report 2531 and/or machine settings recommendation report 2536 can provide a summary comparing the operation of agricultural machine set 1110 before and after implementation of the one or more recommendations described above for machine settings recommendation report 2536.

In some embodiments, data processing mechanism 2500 can generate agricultural machine monitoring report 2532 as one of reports 2530. Agricultural machine monitoring report 2532 can be used, for example, to monitor or keep track of one or more parameters of one or more agricultural machines of an agricultural machine set.

In one example of agricultural machine monitoring report 2532, operational data set 1300 transmitted by data gathering mechanism 1310 can be parsed by data processing mechanism 2500 to generate an agricultural machine parameter set about agricultural machine 1110. In some embodiments, data processing mechanism 2500 parses operational data set 1300 as received from network 1500 during operation of agricultural machine 1110. In other embodiments, data processing mechanism 2500 can parse operational data set 1300 after information from operational data set 1300 has been combined or stored into combined data set 2511. There can be examples where the agricultural machine parameter set can be based on, for example, the operational, mechanical, and/or production parameters previously described with respect to agricultural machine 1110.

In the present example, with the agricultural machine parameter set established, data processing mechanism 2500 can generate agricultural machine monitoring report 2532 to comprise a summary of information from the agricultural machine parameter set for agricultural machine 1110, agricultural machine 2120, and/or agricultural machine set 2100. As an example, the agricultural machine monitoring report 2532 can provide information about current or past settings or operations of agricultural machine 1110, such as a ground speed, an average speed, and/or a harvested area per unit of time. In some examples, agricultural machine monitoring report 2532 can be updated in real time when presented at a screen of an electronic terminal of one or more of the clients 2700.

In the same or other examples, the information in the agricultural machine parameter set can be analyzed to generate information or recommendations regarding one or more maintenance operations for one or more agricultural machines of agricultural machine set 2100. In some embodiments, the maintenance operations could comprise one or more of preventive maintenance operations, scheduled maintenance operations, and/or required maintenance operations for the agricultural machines of agricultural machine set 2100. As an example, data processing mechanism 2500 could be set to recognize and report whether agricultural machine 2110 has been operated nonstop past an allotted limit, such that an operator or equipment change is required, or such that a preventive maintenance should be performed.

There can be examples where the agricultural machine monitoring report can comprise one or more operating recommendations for adjusting at least one of a machine setting or an operating technique of agricultural machine 1110. As an example, the one or more operating recommendations can be based on an analysis of the first agricultural machine parameter set for agricultural machine 1110. In the same or other embodiments, the one or more operating recommendations can be delivered during the operation of agricultural machine 1110.

As a result, the one or more operating recommendations can be received “on the go” by an operator of agricultural machine 1110 to enhance performance or production. In one example, parameters such as grain loss, tailings return, blower fan speed, concave settings, chaffer and sieve settings, and ground speed could be monitored as part of the first agricultural machine parameter set, and could be analyzed to generate the one or more operating recommendations for agricultural machine 1110 such as to improve the volume or quality of grain collected. In another example, parameters such as ground speed, turbo boost pressure, and/or reverser operation could be monitored to identify a current operating condition that could be detrimental to agricultural machine 1110, and could be analyzed to generate the one or more operating recommendations advising a change in operating technique to avoid a mechanical failure of agricultural machine 1110.

Agricultural machine monitoring report 2532 need not be fully automated in some embodiments. For example, in one embodiment, the analyses described above can be fully performed by data processing mechanism 2500. In another embodiment, an analyst of data processing mechanism 2500 may be in contact with an operator of agricultural machine 1110 while agricultural machine 1110 is operated. In such an example, the analyst can review the first agricultural machine parameter set for agricultural machine 1110, and provide the one or more operating recommendations as part of agricultural machine monitoring report 2532. There can be examples where the one or more recommendations provided by the analyst as part of agricultural machine monitoring report 2532 can be voice-based, such as when the analyst and the operator are in contact via telephone or intercom, or visual-based, such as when the recommendations are displayed to the operator via, for example, operation monitor 1211.

In some embodiments, data processing mechanism 2500 can be further coupled to statistically significant data gathering mechanism population 2400, and configured to receive crop production data from population 2400 for at least one of a market or a geographical area. In the same or other embodiments, the crop production data can be processed and/or stored as part of combined data set 2511 (FIG. 2). There can be examples where the population of data gathering mechanisms comprises one of data gathering mechanism set 1200 (FIGS. 1-2) or data gathering mechanism set 2200 (FIG. 2). Data processing mechanism can be configured to generate an aggregated data set based on a macro aggregation of the received crop production data from the population 2400 for the market or the geographical area. In one example, the aggregated data set can comprise information about the operations or performance of one or more agricultural machines for a transcurring timeframe, such as a presently transcurring harvesting season.

The aggregated data set generated by data processing mechanism 2500 can be used to generate several different reports in some embodiments. In one example of such embodiments, data processing mechanism 2500 can be configured to generate historical comparison report 2533 as one of reports 2530. Historical comparison report 2533 can be used to assess performance of an agricultural machine set, such as agricultural machine set 2100, against prior performance of the same agricultural machine set. In some examples, historical comparison report 2533 can take account of different numbers, types, models, brands, and/or configurations of agricultural machines of the agricultural machine set from one season, crop, and/or geography to another.

In one example, when generating historical comparison report 2533 for agricultural machine set 2100, data processing mechanism 2500 can generate a historical aggregated data set by deriving information from combined data set 2511 about one or more historical operations of agricultural machines of agricultural machine set 2100. In the same or other examples, the historical aggregated data set can comprise information about the operations or performance of agricultural machine set 2100 through one or more prior seasons, such as prior harvesting seasons. With the historical aggregated data set generated, data processing mechanism 2500 can compare one or more parameters of the aggregated data set for agricultural machine set 2100 against one or more parameters of the historical aggregated data set for agricultural machine set 2100.

Historical comparison report 2533 can thus comprise a summary of such comparison by data processing mechanism 2500. There can be examples where historical comparison report 2533 can be similar or otherwise comprise aspects of performance benchmark report 2531. In some examples, historical comparison report 2533 can be refreshed as the aggregated data set is updated with new data received by data processing mechanism 2500. In the same or other examples, historical comparison report 2533 can be refreshed in real time.

Data processing mechanism 2500 can also be configured in some embodiments to generate an estimated performance report 2534 using the aggregated data set, where the aggregated data set comprises a yield parameter and a geographical location parameter related to at least a portion of population 2400 of data gathering mechanisms. With such information, data processing mechanism 2500 can be configured to generate estimated performance report 2534 based on the yield parameter and the geographical location parameter such that estimated performance report 2534 can comprise a predicted or estimated yield per geographical location throughout a completion of a predetermined timeframe. In some embodiments, the predetermined timeframe can end, for example, at completion of the presently transcurring harvesting season. In the same or other embodiments, data processing mechanism 2500 can compare the yield and geographical location parameters against yield information for a corresponding geographical location to determine the predicted or estimated yield for estimated performance report 2534. As an example, the yield information for the corresponding geographical location can be based on a yield report from an industry or government organization such as the USDA, and/or from historical yield data derived from combined data set 2511 for the corresponding geographical location.

There can also be examples where data processing mechanism 2500 can be configured to generate an estimated market effect report 2535. In some examples, the estimated market effect report 2535 can be used to forecast the effects of current operations of one or more agricultural machine sets, such as agricultural machine set 2100, on market parameters such as crop prices. In the same or other examples, estimated market effect report 2535 can be derived from the predicted or estimated yield calculated for estimated performance report 2534 above. In such examples, combined data set 2511 can comprise a market conditions set with information such as current market crop prices, current market crop sizes, historical market crop prices, and/or historical market crop sizes. As seen in FIG. 2, there can be examples where data processing mechanism 2500 can be communicatively coupled to market 2600 receive information for the market conditions set. Data gathering mechanism can utilize the predicted or estimated yield for the crop throughout the completion of the predetermined timeframe in order to estimate a predicted crop size for the corresponding geographical location. With the predicted crop size information, data gathering mechanism can compare such predicted crop size with the market conditions set to determine or predict, for example, how the predicted crop size may affect current or future crop prices. A summary of such findings or predictions can then be presented by data processing mechanism 2500 as part of estimated market effect report 2535. In the same or other examples, estimated market effect report 2535 can be updated in real time.

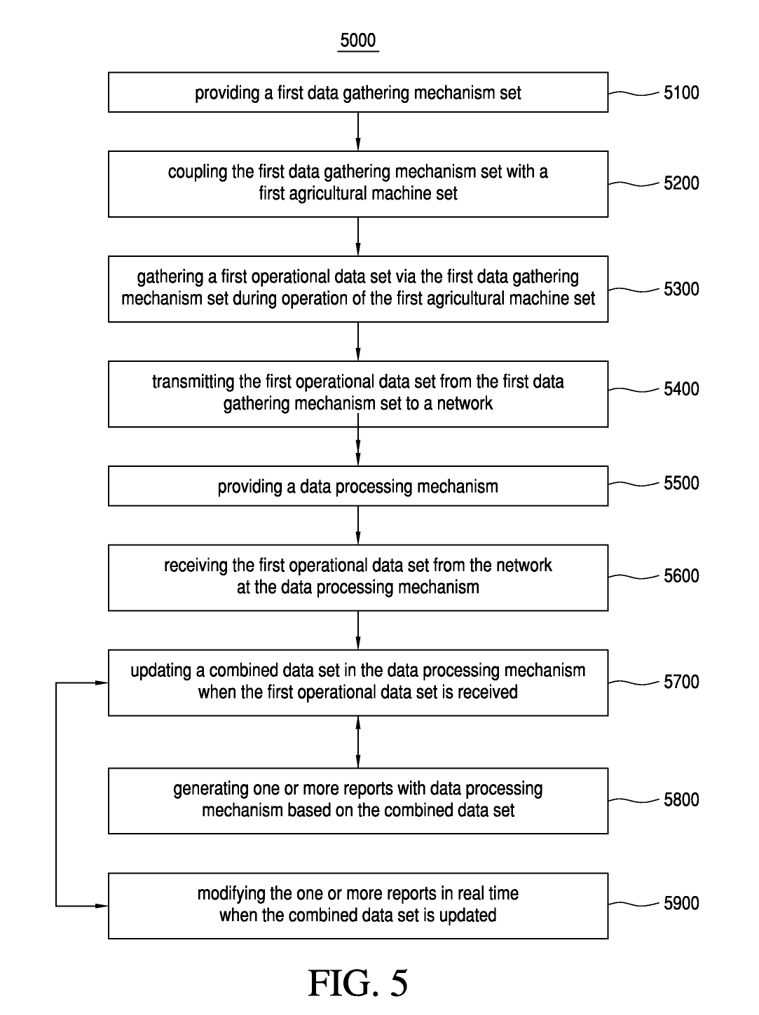

Continuing with the figures, FIG. 5 illustrates a flowchart for a method 5000 that can be used for providing an agricultural reporting mechanism. In some embodiments, the agricultural reporting mechanism can be similar to system 1000 as described for FIGS. 1-2. Method 5000 is merely exemplary and is not limited to the embodiments presented herein, and can be employed in many different embodiments or examples not specifically depicted or described herein.

Method 5000 comprises block 5100 for providing a first data gathering mechanism set. In some examples, the first data gathering mechanism set of block 5100 can be similar to one of data gathering mechanisms 1200 (FIG. 1-2), or 2200 (FIG. 2). In some examples, the first data gathering mechanism set can comprise a single data gathering mechanism, as shown in FIG. 2 for data gathering mechanism set 1200 with respect to data gathering mechanism 1210. In other embodiments, the first data gathering mechanism set can comprise a plurality of data gathering mechanisms, as also shown in FIG. 2 for data gathering mechanism set 2200 with respect to data gathering mechanisms 2210 and 2220.

Block 5200 of method 5000 comprises coupling the first data gathering mechanism set of block 5200 with a first agricultural machine set. In some examples, the first agricultural machine set can be similar to one of agricultural machine sets 1100 (FIG. 1-2) or 2100 (FIG. 2), and could comprise a single agricultural machine or a plurality of agricultural machines. Block 5200 can comprise in some embodiments coupling a first data gathering mechanism of the first data gathering mechanism with a first agricultural machine of the first data gathering mechanism set. In one example, the first agricultural machine can be similar to agricultural machine 1110, and the first data gathering mechanism can be similar to data gathering mechanism 1210 as coupled to agricultural machine 1110 (FIGS. 1-2).

Block 5300 of method 5000 comprises gathering a first operational data set via the first data gathering mechanism set during operation of the first agricultural machine set. There can be embodiments of block 5300 where the first operational data set can be similar to operational data set 1300 from data gathering mechanism 1200 (FIGS. 1-2), or to operational data set 2300 from data gathering mechanism 2200 (FIG. 2). In some examples, the first data gathering mechanism described above can be used to gather first operational data, such as operational data 1310, as part of the first operational data set of block 5300. The first data gathering mechanism can gather the first operational data using elements similar to those described above in FIG. 1 for data gathering mechanism 1210, such as GPS receiver 1212, crop production sensors 1214, and/or operation monitor 1211.

Block 5400 of method 5000 comprises transmitting the first operational data set of block 5300 from the first data gathering mechanism set of block 5200 to a network. There can be embodiments where the first operational data can be transmitted via transmitter 1213 (FIG. 1), as described above for data gathering mechanism 1210 (FIGS. 1-2). In some examples, the network to which the first operational data set is transmitted can be similar to network 1500 (FIGS. 1-2). There can be examples where the first operational data described in block 5300 can be transmitted in real time to the network. For example, the first operational data can be transmitted continuously to the network during the operation of the first agricultural machine. In the same or other examples, the first operational data can be transmitted to the network upon completion of a task during the operation of the first agricultural machine.

Method 5000 also comprises block 5500 for providing a data processing mechanism, where the data processing mechanism can be similar to data processing mechanism 2500 (FIG. 2) in some examples. Providing the data processing mechanism can comprise providing a database such as database 2510 (FIG. 2), and providing a processor such as processor 2520 (FIG. 2) coupled to the database.

Block 5600 of method 5000 comprises receiving the first operational data set of block 5300 from the network at the data processing mechanism of block 5500. In some examples, the data processing mechanism can be coupled to the network via an internet connection. There can also be embodiments where the data processing mechanism of block 5500 and/or the first data gathering mechanism set of block 5100 couple wirelessly to the network, such as through a cellular network interface or a Wi-Fi interface.

Block 5700 of method 5000 comprises updating a combined data set in the data processing mechanism when the first operational data set is received. In some embodiments, the combined data set can be similar to combined data set 2511 in database 2510 of data processing mechanism 2500 (FIG. 2). In the same or other embodiments, the first operational data set can be transformed, modified, analyzed, and/or or otherwise processed by the processor described for block 5500, where the processor can, based on its processing of the first operational data set, control the database to update the combined data set as needed. In the same or other embodiments, the first operational data set can be stored in the database as part of the combined data set after being processed by the processor. There can be examples where the combined data set is updated in real time as the first operational data set keeps being received by the data processing mechanism and/or during the operation of the first agricultural machine set.

Method 5000 also comprises block 5800 for generating one or more reports with the data processing mechanism based on the combined data set. In some examples, the one or more reports of method 5000 can be similar or identical to reports 2530 described above for system 1000, and could be configured for printing or for presentation at a screen of an electronic terminal of one or more of clients 2700 coupled to the data processing mechanism. For example, the one or more reports of block 5800 can comprise a report similar to performance benchmark report 2531 as described above, based on a comparison between benchmark data against information from the first operational data set of block 5300. In the same or other examples, the one or more reports of block 5800 can comprise a report similar to agricultural machine monitoring report 2532 as described above, capable of presenting information regarding a maintenance operation for at least a first agricultural machine of the agricultural machine set of block 5200.

There can also be embodiments where the one or more reports of block 5800 can comprise reports based on an aggregated data set derived from macro aggregation of crop information. For example, the reports based on the aggregated data set can be similar to one or more of historical comparison report 2533, estimated performance report 2534 and/or estimated market effect report 2535 as described above for system 1000.

Block 5900 of method 5000 comprises modifying the one or more reports of block 5800 in real time when the combined data set is updated. As an example, block 5700 may be repeated after block 5800 if the first data gathering mechanism continues transmitting data for the first operational data set to the network per block 5400. Such an arrangement would permit the one or more reports to be updated in real time in some embodiments, such as when the one or more reports are presented at a screen of an electronic terminal. In the same or other embodiments, the macro-aggregation of crop information described above could also be performed in real time by the data processing mechanism to further inform the modification of the one or more reports in block 5900. There can be embodiments of method 5000 where blocks 5900 and 5700 can keep alternating to maintain the one or more reports updated.

In some examples, one or more of the different blocks of method 5000 can be combined into a single block or performed simultaneously, and/or the sequence of such procedures can be changed. For example, blocks 5800 and 5900 can be combined considered part of the same block in some implementations. As another example, block 5500 can be executed before one or more of blocks 5100-5400 in the same or other implementations. There can also be examples where some of the steps of method 5000 can be subdivided into several sub-steps. For example, block 5600 can further comprise the sub-step of processing and/or storing the first operational data set as part of the combined data set in some implementations. There can also be examples where method 5000 can comprise further or different procedures. As an example, method 5000 could comprise another block for coupling the data processing mechanism to a market to receive information related to market conditions. Other variations can be implemented for method 5000 without departing from the scope of the present disclosure.

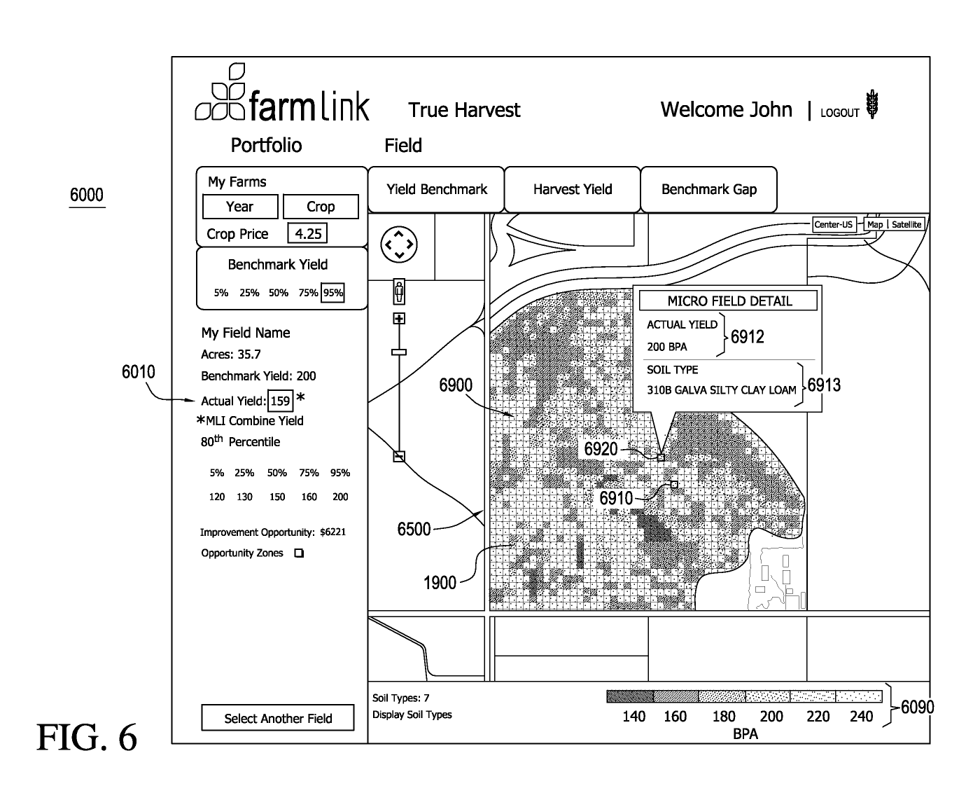

FIG. 6 illustrates an exemplary view of yield report 6000 in accordance with the present disclosure. Yield report 6000 is configured to present yield information for a harvest field, such as harvest field 6900 after harvesting thereof. In some examples, yield report 6000 can comprise one of the reports 2530 that can be generated by data processing mechanism 2500 from system 1000 (FIG. 2). In particular, system 1000 can be configured to process aggregate harvest data 2800 gathered by a plurality of data gathering mechanism sets for a plurality of harvest fields. For instance, as seen in FIG. 2, aggregate harvest data 2800 can comprise or be gathered from operational data 1310, 2310, 2320, and/or 2410 sent to data processing mechanism 2500 by data gathering mechanisms 1210, 2210, 2220, and/or 2400 via network 1500 as their respective harvest fields are harvested. In the same or other examples, aggregate harvest data 2800 can be sent and/or received in real time during harvesting, and can be stored in database 2510 as part of combined data set 2511.

Data processing mechanism 2500 can comprise data processing module 2550 for processing aggregate data set 2700 and/or combined data set 2511 via processor 2520 to generate reports 2530. For instance, data processing module 2550 can be a software module that can be stored in physical memory, such as memory 408 and/or hard drive 314 (FIG. 3), and/or that can be implemented via processor 2520.

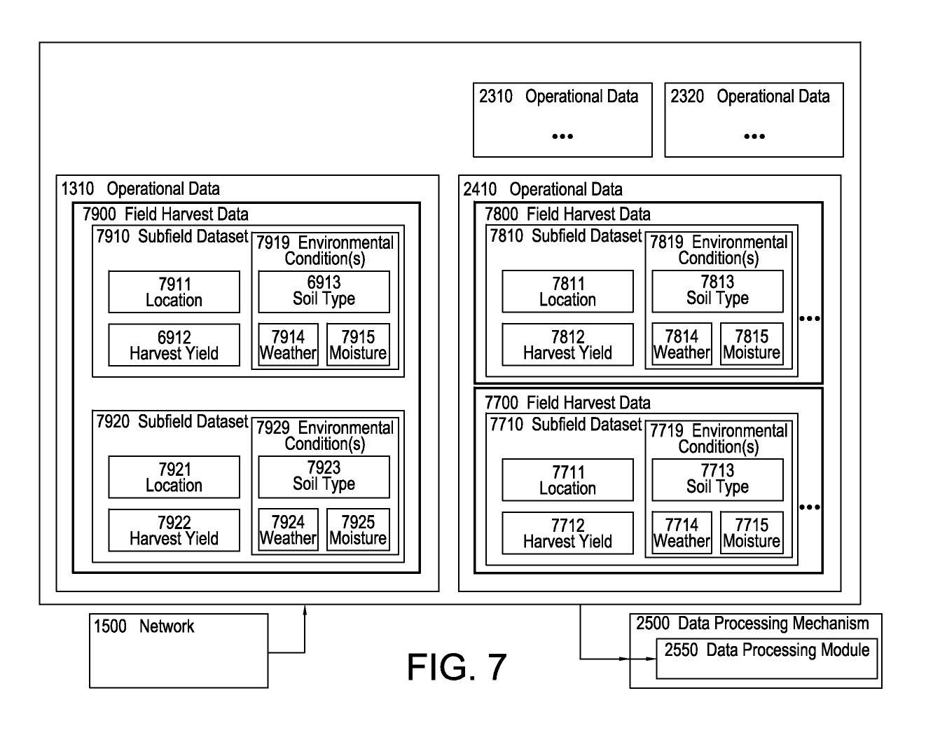

In some examples, data processing module 2550 can receive aggregate data set 2700 via database 2510 and/or as part of combined data set 2511. FIG. 7 illustrates several portions or data of aggregate data set 2700 that can be received by data processing module 2550. For instance, data processing module 2550 can be configured to receive field harvest data 7900 of harvest field 1900 (FIG. 1, 2), and to generate yield report 6000 (FIG. 6) based on field harvest data 7900. In some examples, field harvest data 7900 can be or can comprise part of operational data 1310 gathered by data gathering mechanism 1210 from harvest field 1900.

As can be seen in FIG. 6, harvest field 1900 can be subdivided into a plurality of microfields or subspaces 6900. Each of subspaces 6900 can correspond to a portion of harvest field 1900 harvested by agricultural machine set 1100 (FIGS. 1-2) per unit of time. In one example, the size of subspaces 6900 can be determined based on the size of the harvesting head of agricultural machine set 1100 as it traverses harvest field 1900 per unit of time and/or per traversed distance. Thus, as agricultural machine set 1100 harvests along harvest field 1900 (FIGS. 1-2), data gathering mechanism 1200 can transmit a plurality of subspace datasets with harvest information for corresponding ones of subspaces 6900 as part of field harvest data 7900. (FIGS. 6-7).

In the present example, subspaces 6900 of harvest field 1900 comprise subspace 6910, and the plurality of subspace datasets comprises subspace dataset 7910 for subspace 6910. Subspace dataset 7910 comprises several datapoints in the present embodiment, such as subspace location 7911, and subspace harvest yield 6912. Similarly, subspaces 6900 of harvest field 1900 comprise subspace 6920, and the plurality of subspace datasets comprises subspace dataset 7920 for subspace 6920. Subspace dataset 7920 comprises several datapoints, such as subspace location 7921, and subspace harvest yield 7922. The rest of subspaces 6900 can have corresponding subspace datasets therefor similar to subspace datasets 79110 and 7920 as part of field harvest data 7900.

Data processing module 2550 can be configured to calculate, from the plurality of subspace datasets of field harvest data 7900, field harvest yield 6010 of harvest field 1900, where yield report 6000 can be configured by data processing module 2550 to present field harvest yield 6010 thereat. As an example, data processing module 2550 can aggregate the subspace harvest yields corresponding to each of subspaces 6900, including subspace harvest yields 6912 and 7922, to derive field harvest yield 6010 therefrom.

As seen in FIG. 6, yield report 6000 comprises subspace yield map 6500 showing the plurality of subspaces of harvest field 1900, including subspaces 6910 and 6920. In addition, yield report 6000 is configured to show subspace harvest yield 6912 for subspace 6910 when subspace 6910 is selected at subspace yield map 6500. Similarly, yield report 6000 can also show subspace harvest yield 7922 for subspace 69200 when subspace 6910 is selected at subspace yield map 6500. Thus, yield report 6000 can provide details about the varying yields of harvest field 1900 at a micro-field level in a graphical format for each of subspaces 6900. Subspace yield map 6500 is configured by data processing module 2500 in the present example to show the plurality of subspaces 6900 colored in accordance with their respective subspace harvest yields. For instance, in the present example, subspace harvest yield 6912 for subspace 6910 is 200 bushels per acre (BPA), while subspace harvest yield 6922 for subspace 6920 is lower at 120 bushels per acre (BPA). Accordingly, subspaces 6910 and 6920 are colored differently in subspace yield map 6500 in accordance with yield color scale 6090 such that the yield color for subspace 6910 is yellow and the subspace color for subspace 6920 is dark red. The rest of subspaces 6900 are also correspondingly colored in accordance with yield color scale 6090.

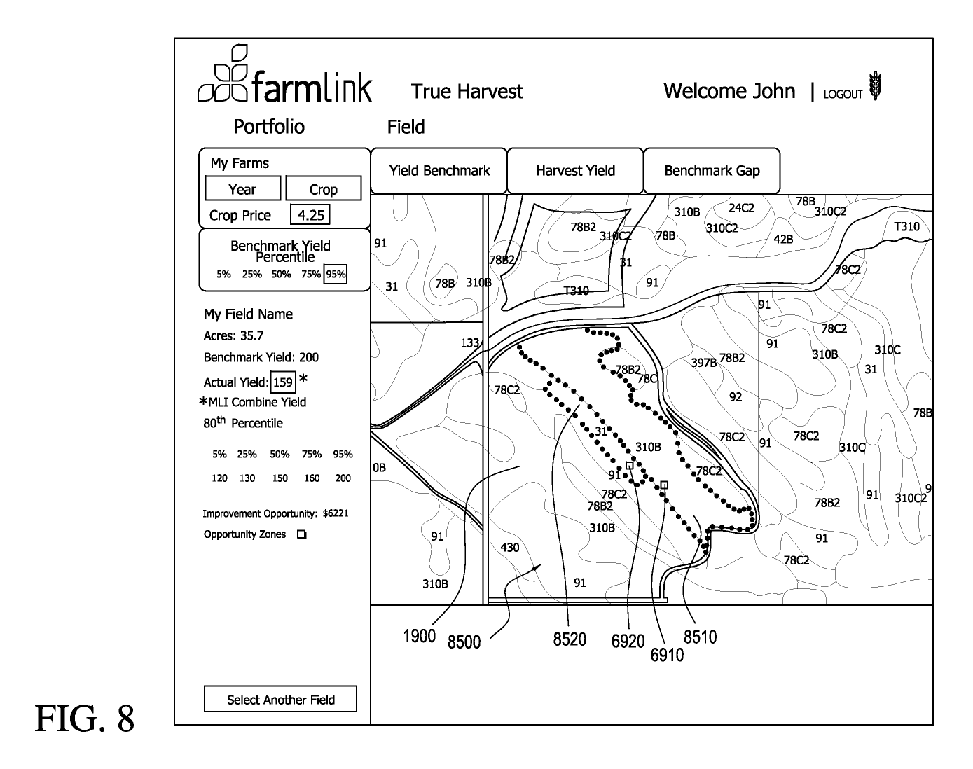

As seen in FIG. 7, the plurality of subspace datasets in field harvest data 7900 for harvest field 1900 comprises a plurality of soil type entries. For example, subspace dataset 7910 for subspace 6910 comprises subspace soil-type 6913, while subspace dataset 7920 for subspace 6920 comprises subspace soil-type 7923. FIG. 8 illustrates soil-zones map 8500 as generated by data processing module 2550 for harvest field 1900, demarcating different soil zones for different soil types therein. For instance, soil zones map 8500 demarcates soil zone 8510, which comprises the location of subspace 6910, and thus correlates subspace soil type 6913 for subspace 6910 as type “310B” translates to Galva Silty Clay Loam type soil. Similarly, soil zones map 8500 demarcates soil zone 8520, which comprises the location of subspace 6920, and thus correlates subspace soil type 7923 for subspace 6920 as type “31” which translates to Afton Silty Clay Loam type soil.

In some examples, the subspace soil type data for the boundaries of the soil zones for soil zones map 8500 can be received by data processing module 2550 based on soil survey data that can be pre-stored, for example, in database 2510. For instance, such soil survey data can be established or derived from a government publication or survey. There can also be examples where the subspace soil type data for the soil zones of soil zones map 8500 can be received by data processing module 2550 from field harvest data 7900 as part of operational data 1310. For instance, data gathering mechanism 1210 and/or other element(s) of agricultural machine 1110 can determine the subspace soil type data for the different subspaces 6900 as they are harvested, and then send such subspace soil type data as part of field harvest data 7900. Data processing module 2550 can be configured to present the subspace soil type for specific subspaces when selected. For instance, as seen in FIG. 6, when subspace 6910 is selected, yield report 6000 presents subspace harvest soil-type 6913 along with subspace harvest yield 6912 therefor.

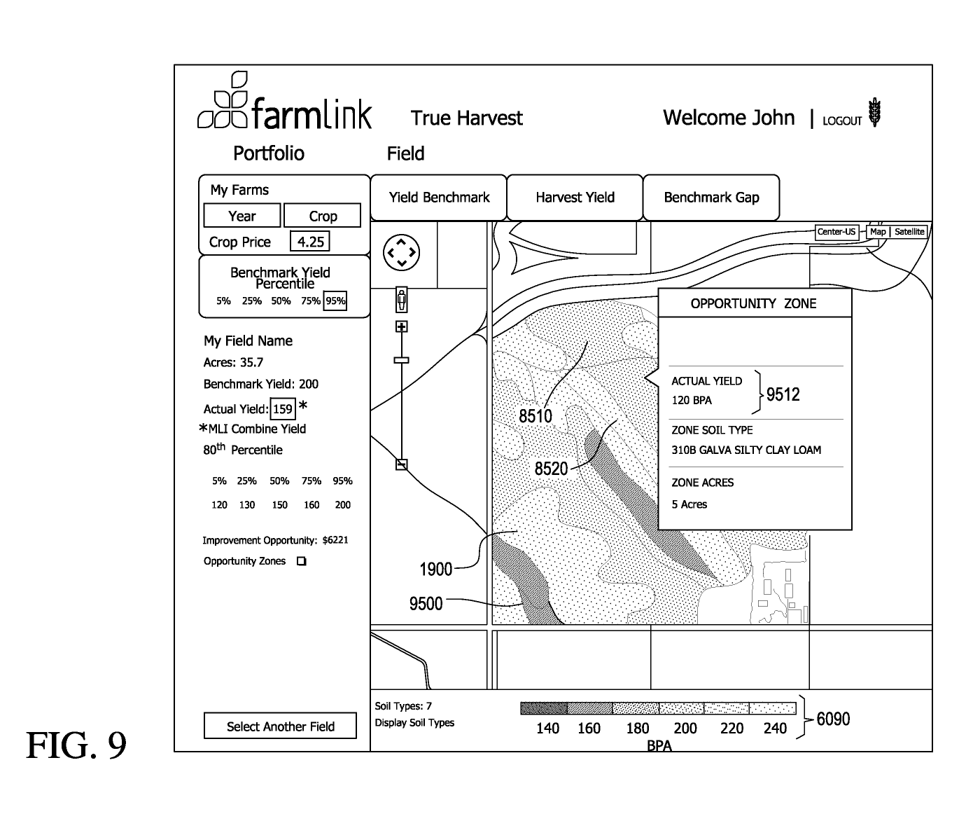

Data processing module 2550 can be configured to calculate soil zone yields for the different soil zones of harvest field 1900. FIG. 9 illustrates soil-zones yield map 9500 as generated by data processing module 2550 for harvest field 1900, demarcating different soil zones for different soil types therein and presenting soil zone yields therefor. For instance, with respect to soil zone 8510 data processing module 2550 can be configured to parse the plurality of subspace datasets of field harvest data 7900 (FIG. 7) to determine which of the subspace datasets comprise a subspace location matching the boundaries of soil zone 8510. As an example, data processing module 2550 will access subspace location 7911 while parsing subspace dataset 7910, and identify thereby that subspace 6910 falls within the boundaries of soil zone 8510.

In the same or other implementations, data processing module 2550 can be configured to parse the plurality of subspace datasets of field harvest data 7900 (FIG. 7) to determine which of the subspace datasets share the same soil-type value in their respective subspace soil type data and are contiguous to each other. As an example, data processing module 2550 can access subspace soil type 6913 while parsing subspace dataset 7910 for subspace 6910, and can determine which other subspaces bounding subspace 6910 and contiguous with each other share the soil-type value of subspace soil type 6913.

Once the subspaces of subspaces 6900 that are comprised by soil zone 8510 are determined, data processing module 2550 can aggregate the respective subspace harvest yields thereof to determine soil zone yield 9512 of soil zone 8510. As seen in FIG. 9, soil zone yield 9512 for soil zone 8510 can be presented when soil zone 8510 is selected at soil-zones yield map 9500. Data processing module 2550 can similarly calculate and present a soil zone yield for soil zone 8520 and for the other soil zones of harvest field 1900. In some examples, soil zones yield map 9500 can be configured by data processing module 2550 to illustrate the different soil zones in different colors depending on their respective soil zone yields. For example, as seen in FIG. 9, soil zone 8510 is illustrated in a yield color corresponding to soil zone yield 9512 thereof pursuant to yield color scale 6090.

As discussed above, data processing module 2550 is configured to receive aggregate harvest data 2800 (FIG. 7) from the plurality of harvest fields harvested by data gathering mechanisms 1210, 2210, 2220, and/or 2400, including field harvest data 7900 for harvest field 1900 as part of operational data 1310 (FIGS. 2, 7). In addition, data processing module 2550 can be configured to calculate, from aggregate harvest data 2800, a subspace yield benchmark for a subspace of a harvest field.

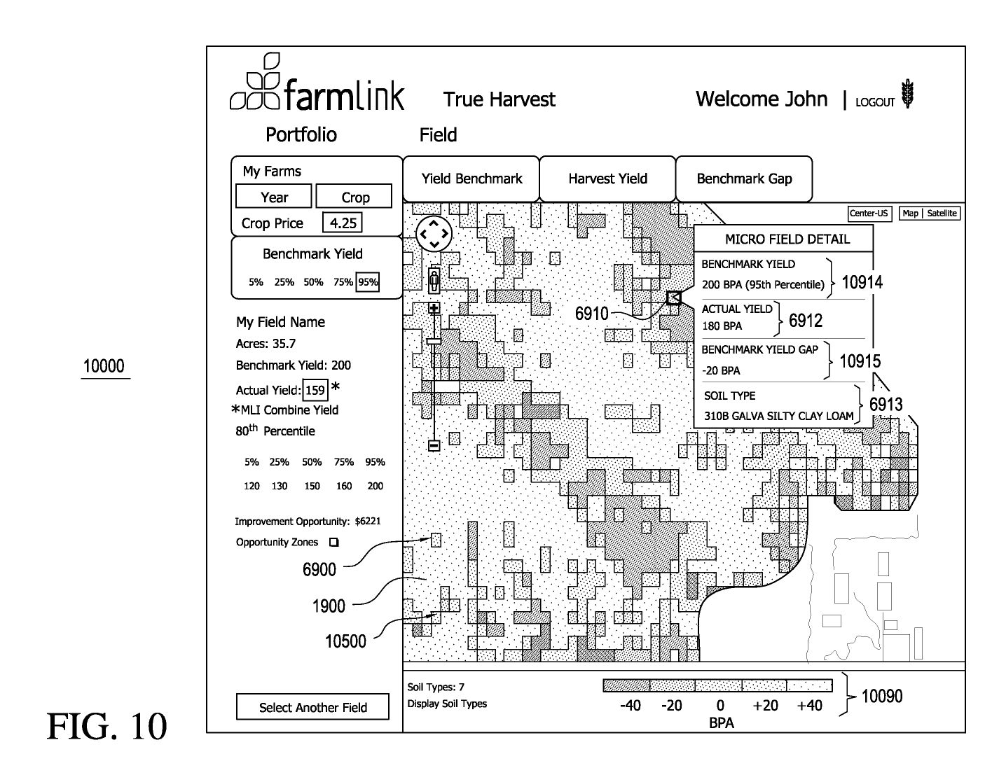

As an example, FIG. 10 presents subspace benchmark report 10000 of harvest field 1900, showing subspace yield benchmark 10914 for subspace 6910 as calculated by data processing module 2550. Subspace yield benchmark 10914 represents a benchmark yield to be targeted for subspace 6910, based on subspace harvest yield data received in aggregate harvest data 2800 from other subspaces of other harvest fields that share one or more similar environment conditions with subspace 6910. For instance, the one or more similar environment conditions can be a subspace soil type condition, a subspace weather condition, a subspace moisture condition, a subspace seed type(s), a subspace fertilizer type(s), a subspace fertilizer amount, a subspace fertilizer date(s), a subspace pesticide type(s), a subspace pesticide amount, a subspace pesticide date(s), a subspace planting date, a subspace planting depth, a subspace topology, a subspace seed spacing, a subspace planting moisture, a subspace irrigation date(s), a subspace irrigation amount, a subspace growing degree days, a subspace canopy temperatures(s), a subspace wind measurement(s), and/or a subspace soil compaction measurement(s), among others.

As seen in FIG. 7, aggregate harvest data 2800 can comprise harvest data from operational data 2310, 2320, and 2410 in addition to field harvest data 7900 of field 1900. For instance, aggregate harvest data 2800 comprises, as part of operational data 2410, field harvest data 7800 and 7700 with corresponding subspace datasets 7810 and 7710 from different respective harvest fields harvested by data gathering mechanism population 2400 (FIG. 2). Each of such aggregate subspace datasets comprises an aggregate subspace harvest yield and aggregate subspace environment condition(s).

For example, besides subspace location 7811 and subspace harvest yield 7812, subspace dataset 7810 of field harvest data 7800 also includes environment condition(s) 7819 comprising subspace soil type 7813, subspace weather 7814, and/or subspace moisture 7815. Similarly, besides subspace location 7711 and subspace harvest yield 7712, subspace dataset 7710 of field harvest data 7700 also includes environment condition(s) 7719 comprising subspace soil type 7713, subspace weather 7714, and/or subspace moisture 7715.

Subspace datasets 7910 and 7920 in field harvest data 7900 of harvest field 1900 also comprise their respective environment condition(s). For example, besides subspace location 7911 and subspace harvest yield 6912, subspace dataset 7910 of field harvest data 7900 also includes environment condition(s) 7919 comprising subspace soil type 6913, subspace weather 7914, and/or subspace moisture 7915. Similarly, besides subspace location 7921 and subspace harvest yield 7922, subspace dataset 7920 of field harvest data 7900 also includes environment condition(s) 7929 comprising subspace soil type 7923, subspace weather 7924, and/or subspace moisture 7925.

In some examples, environment conditions 7919, 7929, 7810, 7710, and/or other environment conditions of other subfield datasets of aggregate harvest data 2800 can comprise, besides and/or instead of their respective subspace soil type condition, subspace weather condition, and/or subspace moisture condition, other environment condition(s) as remarked above.

With such information described above, data processing module 2550 can calculate subspace yield benchmark 10914 for subspace 6910 (FIG. 10). In particular, in some implementations, data processing module 2550 can parse aggregate harvest data 2800 looking for matching subspace harvest yields (7812, 7712, etc.) whose respective environment condition(s) (soil type 7813, 7713; weather 7814, 7714; moisture 7815, 7715) match or correspond to the environment condition(s) (soil type 6913; weather 7914; moisture 7915) of subspace dataset 7910 of subspace 6910. Once such matching subspace harvest yields are found with respect to the environment condition(s) of subspace 6910, data processing module 2550 can compute a target yield for subspace yield benchmark 10914 (FIG. 10), with respect to, for example, a yield average of such matching subspace harvest yields. In the same or other embodiments, the target yield of subspace yield benchmark 10914 can be established with respect to a target percentile of the yield average of the matching subspace harvest yields. As an example, as seen in FIG. 10, subspace yield benchmark 10914 is set with respect to a 95^{th} percentile of the yields of other subspaces that match or correspond to the environment conditions(s) (soil type 6913; weather 7914; moisture 7915) of subspace dataset 7910 of subspace 6910.

As seen in FIG. 10 for subspace 6910 of harvest field 1900, data processing module 2550 is also configured to calculate subspace yield gap 10915 for subspace harvest yield 6912 relative to subspace yield benchmark 10914. For instance, subspace yield gap 10915 comprises a difference between the actual harvest yield 6912 of subspace 6910 relative to subspace yield benchmark 10914.

Subspace yield gap 10915 can thus indicate whether subspace 6910 over-performing, on par, or under-performing with respect to subspaces of other harvest fields that are similarly situated and/or that have matching or similar environment conditions.

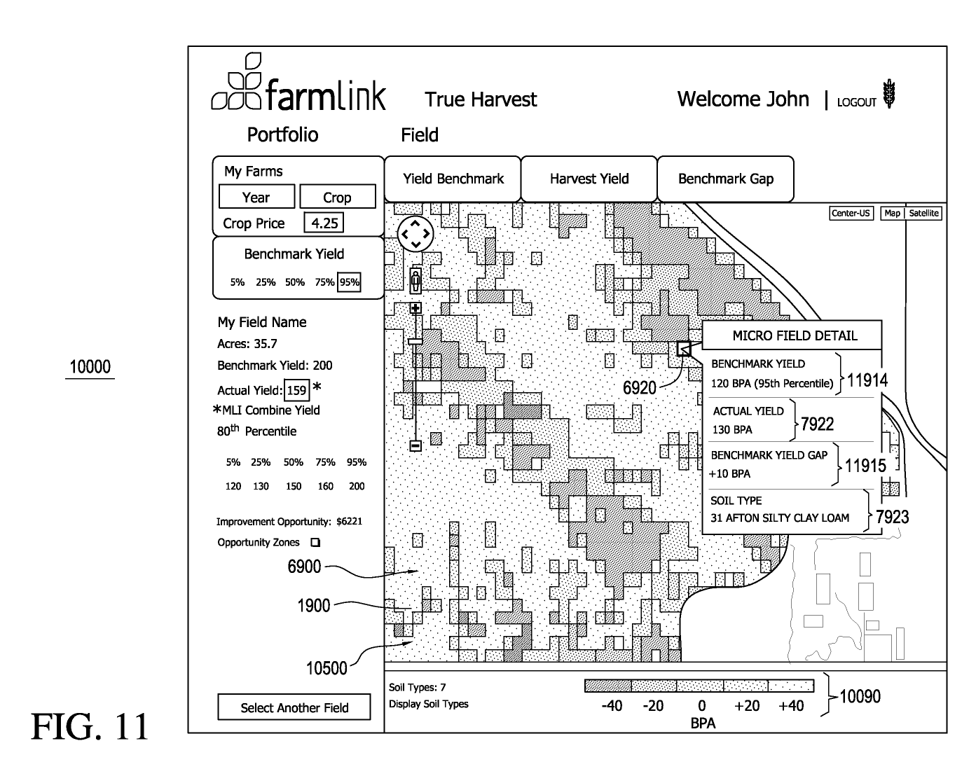

FIG. 11 illustrates another view of subspace benchmark report 10000, but presenting subspace yield benchmark 11914 and subspace yield gap 11915 with respect to subspace 6920 of harvest field 1900 instead. Subspace yield benchmark 11914 and subspace yield gap 11915 for subspace 6920 can be calculated by data processing module 2550 as described above with respect to subspace yield benchmark 10914 and subspace yield gap 10915 of subspace 6910. Thus, subspace benchmark report 10000 can present corresponding yield benchmark and yield gap information for different ones of subspaces 6900 depending on which of such subspaces 6900 is selected.

In addition, as seen in FIGS. 10-11, subspace benchmark report 10000 is configured to present yield gap map 10500 showing different colors for different ones of subspaces 6900 based on their respective subspace yield gaps. For example, the yield gap color of subspace 6910 is different than the yield gap color of subspace 6920 as dictated by their respective subspace yield gaps 10915 and 11915 in accordance with yield gap color scale 10090.

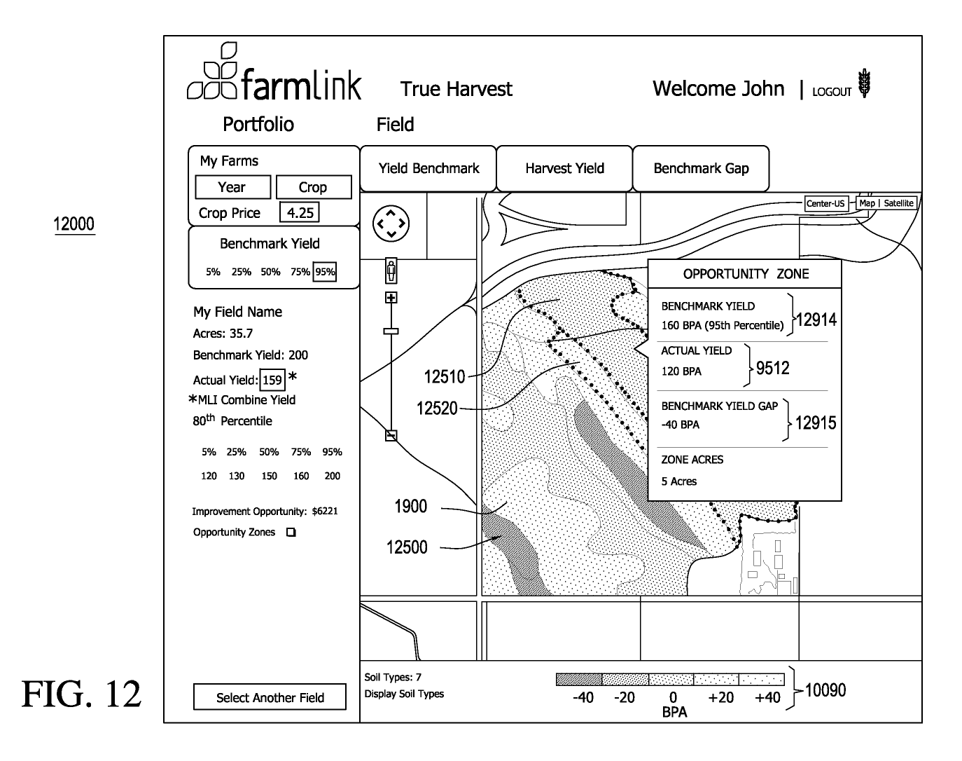

FIG. 12 illustrates a view of field zone benchmark report 12000 generated by data processing module 2550 for harvest field 1900. Field zone benchmark report 12000 can be similar to subspace benchmark report 10000 (FIGS. 10-11), but is configured to benchmark the performance of one or more field zones of harvest field 1900 rather than the performance of individual subspaces thereof. In particular, data processing module 2550 is configured to calculate, from aggregate harvest data 2800, zone yield benchmarks for respective field zones of harvest field 1900, and zone yield gaps for such field zones relative to the zone yield benchmarks. For instance, as seen in FIG. 12, field zone benchmark report 12000 presents zone yield benchmark 12914 and zone yield gap 12915 for field zone 12510. Field zone 12510 can be similar to soil zone 8510 (FIGS. 8-9). For instance, field zone 12510 can be demarcated based on soil type like soil zone 8510. There can also be examples where field zone 12510 can be demarcated based on other environment conditions, such as weather or moisture.

Field zone 12510 comprises a plurality of contiguous field zone subspaces of harvest field 1900, including subspace 6910, that share an environment condition, such as soil type. Field harvest data 7900 comprises field zone subspace datasets for the subspaces of field zone 12510, including subspace dataset 7910 for subspace 6910 (FIGS. 6-7). Each of the field zone subspace datasets for field zone 12510 comprises a zone subspace harvest yield, like subspace harvest yield 6912 of subspace dataset 7910 (FIGS. 6-7). In addition, each of the field zone subspace datasets for field zone 12510 matches or corresponds to each other with respect to their respective environment condition(s). For instance, the field zone subspace datasets subspace datasets for field zone 12510 can share the same environment condition(s) of subspace soil type 6913, subspace weather 7914 and/or subspace moisture 7815 of subspace dataset 7910 of subspace 6910.

As also described above, with respect to FIG. 7 aggregate harvest data 2800 comprises aggregate subspace datasets (such as subspace datasets 7810 and 7710), and each of such aggregate subspace datasets comprises an aggregate subspace harvest yield and an aggregate subspace environment condition.

Data processing module 2550 can thus parse aggregate harvest data 2800 looking for matching subspace harvest yields (7812, 7712, etc.) whose respective environment condition(s) (soil type 7813, 7713; weather 7814, 7714; and/or moisture 7815, 7715) match or correspond to the common environment condition(s) (soil type 6913; weather 7914; and/or moisture 7915) of the field zone subspaces of field zone 12510. Once such matching subspace harvest yields are found with respect to the environment condition(s) of field zone 12510, data processing module 2550 can compute a target zone yield for zone yield benchmark 12914 (FIG. 12), with respect to, for example, a yield average of such matching subspace harvest yields. In the same or other embodiments, the target zone yield of zone yield benchmark 12914 can be established with respect to a target percentile of the yield average of the matching subspace harvest yields.

As seen in FIG. 12 for field zone 12510 of harvest field 1900, data processing module 2550 is also configured to calculate zone yield gap 12915 for field zone yield 9512 relative to zone yield benchmark 12914. For instance, zone yield gap 12915 comprises a difference between the actual field zone yield 9512 of field zone 12510 relative to zone yield benchmark 12914. Zone yield gap 12915 can thus indicate whether field zone 12510 is over-performing, on par, or under-performing with respect to subspaces of other harvest fields that are similarly situated and/or that have matching or similar environment condition(s).

In addition to field zone 12510, zone yield gap map 12500 also presents other field zones of harvest field 1900, such as field zone 12520, for which a zone yield benchmark similar to zone yield benchmark 12914, and/or a zone yield gap similar to zone yield gap 12915, can be calculated by data processing module 2550. In addition, as seen in FIG. 12, field zone benchmark report 12000 is configured to present zone yield gap map 12500 showing different colors for different ones of its field zones based on their respective zone yield gaps. For example, the zone yield gap color for field zone 12510 is different than the zone yield gap color of field zone 12520 as dictated by their respective zone yield gaps in accordance with yield gap color scale 10090.

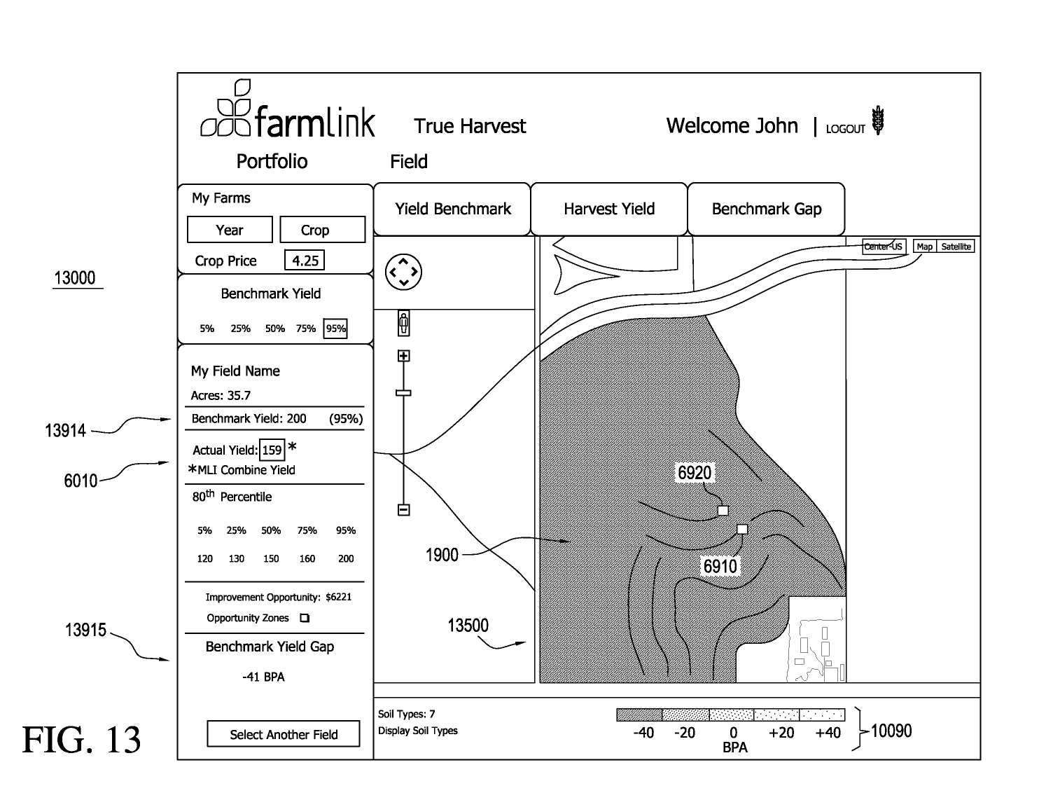

FIG. 13 illustrates a view of field benchmark report 13 generated by data processing module 2550 for harvest field 1900. Field benchmark report 13000 can be similar to subspace benchmark report 10000 (FIGS. 10-11), but is configured to benchmark the performance of harvest field 1900 as a whole rather than the performance of individual subspaces thereof. In particular, data processing module 2550 is configured to calculate, from aggregate harvest data 2800, field yield benchmark 13914 and field yield gap 13915 for harvest field 1900.

Field harvest data 7900 (FIG. 7) comprises subspace datasets for the subspaces of harvest field 1900, including subspace dataset 7910 for subspace 6910, and subspace dataset 7920 for subspace 6920 (FIGS. 6-7). Each of the subspace datasets for field harvest field 1900 comprises a subspace harvest yield, like subspace harvest yield 6912 of subspace dataset 7910, and like subspace harvest yield 7922 of subspace dataset 7920 (FIGS. 6-7). In addition, each of the subspace datasets for harvest field 1900 comprises a subspace environment condition, like subspace soil type 6913, subspace weather 7914, and/or subspace moisture 7915 of subspace dataset 7910.

As also described above, with respect to FIG. 7 aggregate harvest data 2800 comprises aggregate subspace datasets (such as subspace datasets 7810 and 7710), and each of such aggregate subspace datasets comprises an aggregate subspace harvest yield and an aggregate subspace environment condition. For instance, subspace dataset 7810 comprises subspace harvest yield 7812 and at least one of subspace soil type 7813, weather 7814, and/or moisture 7815 as its environment condition(s).

With such information from aggregate harvest data 2800, data processing module 2550 can calculate field yield benchmark 13914 based on the aggregate subspace harvest yields (7812, 7712, etc.) of aggregate harvest data 2800 whose respective aggregate subspace environment conditions (7813, 7814, and/or 7815; 7713, 7714, and/or 7715) match or correspond to the subspace environment conditions (6913, 7914, and/or 7915; 7923, 7924, and/or 7925) of the subspace datasets (7910, 7920, etc.) of field harvest data 7900 for harvest field 1900.

As an example, data processing module 2550 can determine subspace yield benchmarks for each subspace of harvest field 1900, such as described above with respect to subspace yield benchmark 10914 of subspace 6910 (FIG. 10) and subspace yield benchmark 11914 of subspace 6920 (FIG. 11), and can then determine field yield benchmark 13914 (FIG. 13) for harvest field 1900 from the combination of such individual subspace yield benchmarks. For instance, data processing module 2550 can determine subspace environment groupings to group the subspace datasets of field harvest data 7900 based on their environment condition(s), determine a relevance weight for the different subspace environment groupings based on how many subspaces or harvested area of harvest field 1900 each subspace environment grouping represents, and calculate field yield benchmark 13914 via a weighted average of the yield benchmarks of the different subspace environment groupings.

As seen in FIG. 13, data processing module 2550 is also configured to calculate zone yield gap 13915 for harvest field 1900 relative to field yield benchmark 13914. For instance, field yield gap 13915 comprises a difference between the actual field harvest yield 6010 of harvest field 1900 relative to field yield benchmark 13914. Field yield gap 13915 can thus indicate whether harvest field 1900 is over-performing, on par, or under-performing with respect to other harvest fields that are similarly situated and/or that have a combination of matching or similar environment condition(s). In addition, as seen in FIG. 13, field benchmark report 13000 is configured to present field yield gap map 13500 showing harvest field 1900 in a different color based on field yield gap 13915 in accordance with yield gap color scale 10090.

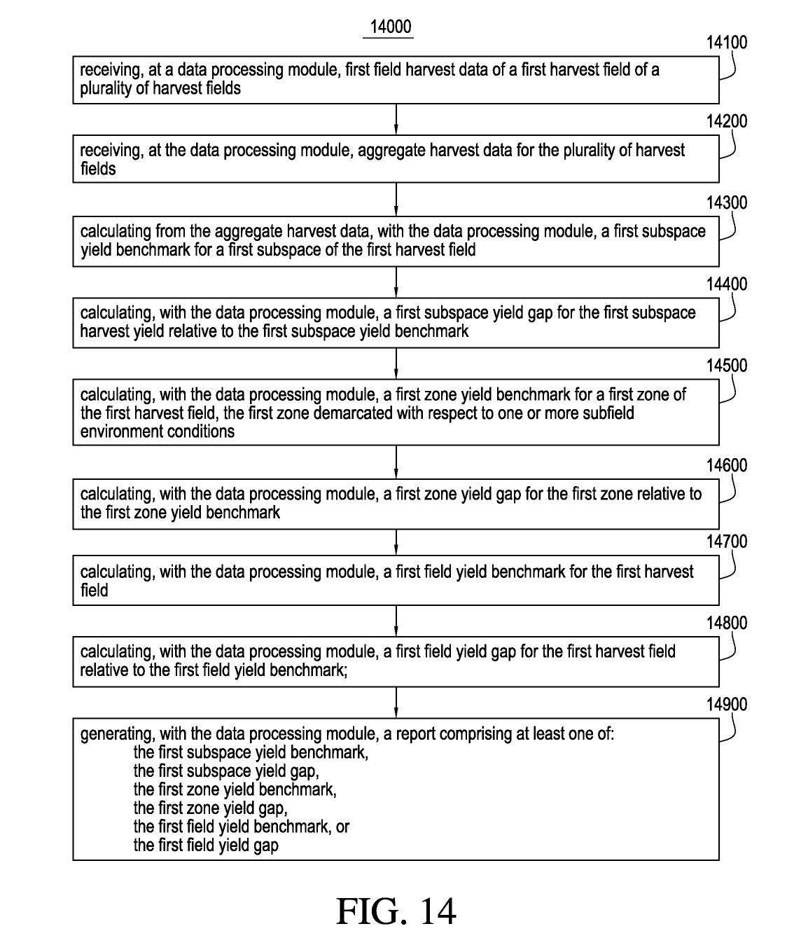

Continuing with the figures, FIG. 14 illustrates a flowchart for a method 14000 that can be used for processing aggregate harvest data gathered by a plurality of data gathering mechanism sets for a plurality of harvest fields. In some examples, the aggregate harvest data can be similar to aggregate harvest data 2800 (FIGS. 2, 7), the data gathering mechanism sets can be similar to data gathering mechanism sets 1200, 2200, 2400, (FIGS. 1-2), and the plurality of harvest fields can be similar to the fields harvested by data gathering mechanism sets 1200, and/or 2200, 2400. In some examples, method 14000 can implement one or more systems as described above with respect to FIGS. 1-13.

Method 14000 comprises block 14100 for receiving, at a data processing module, first field harvest data of a first harvest field of a plurality of harvest fields. The data processing module can be similar to data processing mechanism 2500 and/or data processing module 2550 (FIG. 2). The field harvest data of the first harvest field can be similar to field harvest data 7900 (FIG. 7) for harvest field 1900 (FIGS. 1, 2, 6, 8-13).

Method 14000 also comprises block 14200 for receiving, at the data processing module, aggregate harvest data for the plurality of harvest fields. As described above, the aggregate harvest data can be similar to aggregate harvest data 2800 or portions thereof. In some examples, the aggregate harvest data for the plurality of harvest fields can comprise subfield datasets that may be from a present harvest season and/or from previous or historically averaged harvest seasons for such other harvest fields.

Method 14000 can also comprise block 14300 for calculating from the aggregate harvest data, with the data processing module, a first subspace yield benchmark for a first subspace of the first harvest field. In some examples, the first subspace yield benchmark can be similar to subspace yield benchmark 10914 of subspace 6910 of harvest field 1900 (FIG. 10), or to subspace yield benchmark 11914 of subspace 6920 of harvest field 1900 (FIG. 11).

Method 14000 can also comprise block 14400 for calculating, with the data processing module, a first subspace yield gap for the first subspace harvest yield relative to the first subspace yield benchmark. In some examples, the first subspace yield gap can be similar or can be calculated similar to subspace yield gap 10915 of subspace 6910 of harvest field 1900 (FIG. 10), or to subspace yield gap 11915 of subspace 6920 of harvest field 1900 (FIG. 11).

Method 14000 can also comprise block 14500 for calculating, with the data processing module, a first zone yield benchmark for a first zone of the first harvest field. In some examples, the first zone yield benchmark can be similar or can be calculated similar to zone yield benchmark 12914 for field zone 12510 of harvest field 1900 (FIG. 12). The first zone can be demarcated with respect to one or more subfield environment conditions, as described above with respect to the environment conditions defining field zone 12510.

Method 14000 can also comprise block 14600 for calculating, with the data processing module, a first zone yield gap for the first zone relative to the first zone yield benchmark. In some examples, the first zone yield gap can be similar to zone yield gap 12915 for field zone 12510 (FIG. 12).

Method 14000 can also comprise block 14700 for calculating, with the data processing module, a first field yield benchmark for the first harvest field. In some examples, the first field yield benchmark can be similar to field yield benchmark 13914 for harvest field 1900 (FIG. 13).

Method 14000 can also comprise block 14800 for calculating, with the data processing module, a first field yield gap for the first harvest field relative to the first field yield benchmark. In some examples, the first field yield gap can be similar to field yield gap 13915 for harvest field 1900 (FIG. 13).

Method 14000 can also comprise block 14900 for generating, with the data processing module, a report comprising at least one of the first subspace yield benchmark, the first subspace yield gap, the first zone yield benchmark, the first zone yield gap, the first field yield benchmark, or the first field yield gap. In some examples, the report can be similar to one or more of the reports or illustrations presented and described above with respect to FIGS. 6 and 8-13.

In some examples, one or more of the different blocks of method 14000 can be combined into a single block or performed simultaneously, and/or the sequence of such procedures can be changed. For example, blocks 14100 and 14200 can be combined considered part of the same block in some implementations and/or can be carried out concurrently. There can also be examples where some of the steps of method 14000 can be subdivided into several sub-steps. There can also be examples where method 14000 can comprise further or different procedures, and/or where some blocks can be optional. As an example, one or more of blocks 14300-14900 can be optional in some implementations. Other variations can be implemented for method 14000 without departing from the scope of the present disclosure.

Although the Agricultural Performance Information Systems and Related Methods have been described with reference to specific embodiments, various changes may be made without departing from the spirit or scope of the disclosure. For example, one or more of the data gathering mechanisms of data gathering mechanism population 2400 may couple to data processing mechanism 2500 (FIG. 2) via network 1500 via a wired rather than wireless means.

As another example, field harvest data 7900 (FIG. 7) can be received from data gathering mechanism 1210 (FIGS. 1-2) upon harvesting of harvest field 1900 during a present harvest season. The field harvest data of other harvest fields, with respect to which field harvest data 7900 is compared to determine, for example, subspace yield benchmark 10914 and subspace yield gap 10915 (FIG. 10), can also be gathered during the same present harvest season and/or from previous or historically averaged harvest seasons for such other harvest fields. For example, field harvest data 7800 and/or 7700 (FIG. 7) can comprise one or more subspace datasets (such as subspace dataset 7810 and/or 7710) with data recently received during the present harvest season. If, however, one or more subspaces of field harvest data 7800 and/or 7700 has not been harvested during the present harvest season, its corresponding subspace dataset(s) can comprise data from previous harvest season(s) and/or historically averaged data.

Additional examples of such changes have been given in the foregoing description. Accordingly, the disclosure of embodiments is intended to be illustrative of the scope of the invention and is not intended to be limiting. It is intended that the scope of this application shall be limited only to the extent required by the appended claims. The Agricultural Performance Information Systems and Related Methods discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system for processing aggregate harvest data gathered by a plurality of data gathering mechanism sets for a plurality of harvest fields, the system comprising:
a data processing module configured to:
receive first field harvest data of a first harvest field of the plurality of harvest fields;
receive the aggregate harvest data for the plurality of harvest fields from a database; and
calculate, from the aggregate harvest data, a first subspace yield benchmark for a first subspace of the first harvest field;
wherein:
the aggregate harvest data comprises aggregate subspace datasets from subspaces of the plurality of harvest fields;
each of the aggregate subspace datasets comprises:
an aggregate subspace harvest yield; and
an aggregate subspace environment condition;
the first field harvest data comprises a first subspace dataset of the first subspace of the first harvest field;
the first subspace dataset comprises:
a first subspace harvest yield; and
a first subspace environment condition;
and
the data processing module calculates the first subspace yield benchmark from
the aggregate subspace harvest yields whose respective aggregate subspace environment condition corresponds to the first subspace environment condition of the first harvest field.

2. The system of claim 1, wherein:
the data processing module is configured to:
calculate a first subspace yield gap for the first subspace harvest yield relative to the first subspace yield benchmark.

3. The system of claim 2, wherein:
the data processing module is configured to:
calculate, from the aggregate harvest data, a second subspace yield benchmark for a second subspace of the first harvest field;
calculate a second subspace yield gap for the second subspace harvest yield; and
generate a report configured to present a subspace yield gap map showing:
the first subspace in the first harvest field, colored a first yield gap color corresponding to the first subspace yield gap; and
the second subspace in the first harvest field, colored a second yield gap color corresponding to the second subspace yield gap.

4. A system for processing aggregate harvest data gathered by a plurality of data gathering mechanism sets for a plurality of harvest fields, the system comprising:
a data processing module configured to:
receive first field harvest data of a first harvest field of the plurality of harvest fields; and
generate a report for the first harvest field based on the first field harvest data;
wherein:
the first field harvest data comprises a plurality of subspace datasets for a plurality of subspaces of the first harvest field;
the plurality of subspaces comprise:
a first subspace of the first harvest field; and
a second subspace of the first harvest field;
the plurality of subspace datasets comprise:
a first subspace dataset for the first subspace, comprising:
a first subspace location; and
a first subspace harvest yield;
a second subspace dataset for the second subspace, comprising:
a second subspace location; and
a second subspace harvest yield;
the data processing module is configured to calculate, from the plurality of subspace datasets, a first field harvest yield of the first harvest field; and
the report is configured by the data processing module to present the first field harvest yield of the first harvest field.

5. The system of claim 4, wherein:
the report is configured by the data processing module to present:
a subspace yield map showing:
the plurality of subspaces of the first harvest field;
the first subspace harvest yield for the first subspace when the first subspace is selected at the subspace yield map; and
the second subspace harvest yield for the second subspace when the second subspace is selected at the subspace yield map.

6. The system of claim 4, wherein:
the report is configured by the data processing module to present:
the subspace yield map showing the plurality of subspaces colored in accordance with corresponding subspace harvest yields such that, when the first and second subspace harvest yields differ from each other:
the first subspace is presented in a first yield color; and
the second subspace is presented in a second yield color.

7. The system of claim 4, wherein:
the plurality of subspace datasets for the first harvest field comprise a plurality of soil-types such that:
the first subspace dataset comprises a first subspace soil-type of the first subspace; and
the second subspace dataset comprises a second subspace soil-type of the second subspace;
the first and second subspace soil-types are received by the data processing module from at least one of:
the first field harvest data of the first harvest field; or
a database comprising:
the first subspace soil-type correlated to the first subspace location; and
the second subspace soil-type correlated to the second subspace location;
and
the report is configured to present:
the first subspace harvest soil-type when the first subspace is selected; and
the second subspace harvest soil-type when the second subspace is selected.

8. The system of claim 4, wherein:
the plurality of subspace datasets for the first harvest field comprise a plurality of soil-types such that:
the first subspace dataset comprises a first subspace soil-type of the first subspace; and
the second subspace dataset comprises a second subspace soil-type of the second subspace;
the data processing module is configured to:
calculate a first soil zone yield for a first soil zone of the first harvest field,
the first soil zone bounding first contiguous subspaces that comprise the first subspace and that share the first subspace soil-type,
the first soil zone yield based on subspace harvest yields of the first contiguous subspaces;
and
calculate a second soil zone yield for a second soil zone of the first harvest field,
the second soil zone bounding second contiguous subspaces that comprise the second subspace and that share the second subspace soil-type,
the second soil zone yield based on subspace harvest yields of the second contiguous subspaces;
the report is configured by the data processing module to present:
a soil-zones yield map that:
demarcates the first and second soil zones in the first harvest field; and
illustrates the first and second soil zone yields.

9. The system of claim 8, wherein:
when the first and second soil zone yields differ from each other:
the report is configured by the data processing module to:
illustrate the first soil zone yield via a first yield color for the first soil zone; and
illustrate the second soil zone yields via a second yield color for the second soil zone.

10. The system of claim 4, wherein:
the data processing module is configured to:
receive the aggregate harvest data for the plurality of harvest fields from a database; and
calculate, from the aggregate harvest data, a first subspace yield benchmark for the first subspace of the first harvest field;
the aggregate harvest data comprises aggregate subspace datasets from subspaces of the plurality of harvest fields;
each of the aggregate subspace datasets comprises:
an aggregate subspace harvest yield; and
an aggregate subspace environment condition;
the first subspace dataset of the first subspace of the first harvest field comprises:
the first subspace harvest yield; and
a first subspace environment condition;
and
the data processing module calculates the first subspace yield benchmark from
the aggregate subspace harvest yields whose respective aggregate subspace environment condition corresponds to the first subspace environment condition of the first harvest field.

11. The system of claim 10, wherein:
the first subspace environment condition comprises:
a first subspace soil-type.

12. The system of claim 10, wherein:
the first subspace environment condition comprises one or more of:
a first subspace soil type condition, a first subspace weather condition, a first subspace moisture condition, a first subspace seed type, a first subspace fertilizer type, a first subspace fertilizer amount, a first subspace fertilizer date, a first subspace pesticide type, a first subspace pesticide amount, a first subspace pesticide date, a first subspace planting date, a first subspace planting depth, a first subspace topology, a first subspace seed spacing, a first subspace planting moisture, a first subspace irrigation date, a first subspace irrigation amount, a first subspace growing degree days, a first subspace canopy temperatures, a first subspace wind measurement, or a first subspace soil compaction measurement.

13. The system of claim 10, wherein:
to calculate the first subspace yield benchmark, the data processing module determines a target yield with respect to an average of the aggregate subspace harvest yields whose respective aggregate subspace environment condition corresponds to the first subspace environment condition of the first harvest field.

14. The system of claim 10, wherein:
the data processing module is configured to:
calculate a first subspace yield gap for the first subspace harvest yield relative to the first subspace yield benchmark.

15. The system of claim 14, wherein:
the report is configured by the data processing module to present:
the first subspace harvest yield of the first subspace;
the first subspace yield benchmark for the first subspace; and
the first subspace yield gap for the first subspace.

16. The system of claim 14, wherein:
the data processing module is configured to:
calculate, from the aggregate harvest data, a second subspace yield benchmark for the second subspace of the first harvest field; and
calculate a second subspace yield gap for the second subspace harvest yield;
and
the report is configured by the data processing module to present:
a subspace yield gap map showing:
the first subspace in the first harvest field, colored a first yield gap color corresponding to the first subspace yield gap; and
the second subspace in the first harvest field, colored a second yield gap color corresponding to the second subspace yield gap.

17. The system of claim 14, wherein:
the data processing module is configured to calculate a yield gap for each of the plurality of subspaces of the first harvest field; and
the report is configured by the data processing module to present:
a subspace yield gap map showing:
the plurality of subspaces of the first harvest field;
the first subspace yield gap for the first subspace when the first subspace is selected; and
a second subspace yield gap for the second subspace when the second subspace is selected.

18. The system of claim 10, wherein:
the first field harvest data is received from a first agricultural machine set of the plurality of data gathering mechanisms while harvesting the first harvest field during a present harvest season; and
the aggregate harvest data received in real time from the plurality of data gathering mechanisms harvesting the plurality of harvest fields during the present harvest season.

19. The system of claim 4, wherein:
the data processing module is configured to:
receive the aggregate harvest data for the plurality of harvest fields from a database;
calculate, from the aggregate harvest data, a first zone yield benchmark for a first zone of the first harvest field; and
calculate a first zone yield gap for the first zone relative to the first zone yield benchmark;
the first zone comprises first zone subspaces of the plurality of subspaces of the first harvest field;
the plurality of subspace datasets of the first harvest field comprises first zone subspace datasets for the first zone;
each of the first zone subspace datasets:
comprises a first zone subspace harvest yield; and
shares a first zone subspace environment condition;
the aggregate harvest data comprises aggregate subspace datasets from subspaces of the plurality of harvest fields;
each of the aggregate subspace datasets comprises:
an aggregate subspace harvest yield; and
an aggregate subspace environment condition;
the data processing module calculates the first zone yield benchmark from
the aggregate subspace harvest yields whose respective aggregate subspace environment condition corresponds to the first zone subspace environment condition;
the data processing module calculates a first zone yield from
the first zone subspace harvest yields of the first zone subspace datasets;
and
the data processing mechanism contrasts the first zone yield relative to the first zone yield benchmark to calculate the first zone yield gap.

20. The system of claim 19, wherein:
the data processing module is configured to:
calculate, from the aggregate harvest data, a second zone yield benchmark for a second zone of the second harvest field; and
calculate a second zone yield gap for the second zone relative to the second zone yield benchmark;
the first and second zones are defined by soil type, such that:
the first zone subspace environment condition for the first zone comprises a first zone soil-type; and
a second zone subspace environment condition for the second zone comprises a second zone soil-type;
and
the report is configured by the data processing module to present:
a field zone yield gap map showing:
the first zone in the first harvest field, colored a first yield gap color corresponding to the first zone yield gap; and
the second zone in the first harvest field, colored a second yield gap color corresponding to the second zone yield gap.

21. The system of claim 4, wherein:
the data processing module is configured to:
receive the aggregate harvest data for the plurality of harvest fields from a database;
calculate, from the aggregate harvest data, a first field yield benchmark for the first harvest field; and
calculate a first field yield gap for the first harvest field relative to the first field yield benchmark;
the aggregate harvest data comprises aggregate subspace datasets from subspaces of the plurality of harvest fields;
the aggregate subspace datasets comprise:
aggregate subspace harvest yields; and
aggregate subspace environment conditions;
the plurality of subspace datasets for the first harvest field comprise:
a plurality of subspace harvest yields; and
a plurality of subspace environment conditions;
the data processing module calculates the first field yield benchmark via a weighted averaging of the aggregate subspace harvest yields whose respective aggregate subspace environment conditions correspond to the plurality of subspace environment conditions of the first harvest field;
the data processing module calculates, from the plurality of subspace harvest yields of the first harvest field, a first field yield for the first harvest field;
and
the data processing mechanism contrasts the first field yield relative to the first field yield benchmark to calculate the first field yield gap.

22. A method for processing aggregate harvest data gathered by a plurality of data gathering mechanism sets for a plurality of harvest fields, the method comprising:
receiving, at a data processing module, first field harvest data of a first harvest field of the plurality of harvest fields;
receiving, at the data processing module, the aggregate harvest data for the plurality of harvest fields from a database; and
calculating from the aggregate harvest data, with the data processing module, a first subspace yield benchmark for a first subspace of the first harvest field;
wherein:
the aggregate harvest data comprises aggregate subspace datasets from subspaces of the plurality of harvest fields;
each of the aggregate subspace datasets comprises:
an aggregate subspace harvest yield; and
an aggregate subspace environment condition;
the first field harvest data comprises a first subspace dataset of the first subspace of the first harvest field;
the first subspace dataset comprises:
a first subspace harvest yield; and
a first subspace environment condition;
and
calculating the first subspace yield benchmark comprises:
combining the aggregate subspace harvest yields of the subspaces of the plurality of harvest fields whose respective aggregate subspace environment condition corresponds to the first subspace environment condition of the first harvest field.

23. The method of claim 22, further comprising:
calculating, with the data processing module, at least one of:
a first subspace yield gap for the first subspace harvest yield relative to the first subspace yield benchmark;
a first zone yield benchmark for a first zone of the first harvest field,
the first zone demarcated with respect to one or more subfield environment conditions;
a first zone yield gap for the first zone relative to the first zone yield benchmark;
a first field yield benchmark for the first harvest field; or
a first field yield gap for the first harvest field relative to the first field yield benchmark;
and
generating, with the data processing module, a report comprising at least one of:
the first subspace yield benchmark;
the first subspace yield gap;
the first zone yield benchmark;
the first zone yield gap;
the first field yield benchmark; or
the first field yield gap.
